(19) United States
(12) Patent Application Publication
(10) Pub. No.: US 2003/0204420 A1
(43) Pub. Date: Oct. 30, 2003

(54) Healthcare database management offline backup and synchronization system and method

(76) Inventors: Gordon J. Wilkes, Newmarket (CA); Eric S. Paul, North York (CA); Meetali Acharya, Burlington (CA); Florante Pascual, Mississauga (CA)

Correspondence Address: FRANCIS C. KOWALIK, ESQ., CORPORATE COUNSEL, BAXTER INTERNATIONAL INC., ONE BAXTER PARKWAY, DF2-2E, DEERFIELD, IL, 60015, US

(21) Appl. No.: 10/160,444

(22) Filed: May 31, 2002

Related U.S. Application Data
(63) Continuation-in-part of application No. 10/135,180, filed on Apr. 30, 2002.
(60) Provisional application No. 60/377,027, filed on Apr. 30, 2002.
(60) Provisional application No. 60/376,625, filed on Apr. 30, 2002.
(60) Provisional application No. 60/376,655, filed on Apr. 30, 2002.

(51) Int. Cl. G06F 17/60

(52) U.S. Cl. 705/3

(57) ABSTRACT

A healthcare database management offline backup and synchronization system having an active database for storing active records and an archive database for storing inactive records. The databases are coupled by a communication link and the system is able to transfer and store records that have become inactive from the active database to the archive database. The database records are archived and purged based on predefined rules. The system allows continuous access to a local medical depot computer database on a network even when the network link is severed. The system updates local and central computer databases regularly, while the link is active and synchronizes database records after computer communications are restored.

### RELATED APPLICATIONS

The present application claim s priority from U.S. patent Ser. No. 60/377,027 filed Apr. 30, 2002; U.S. patent Ser. No. 60/376,625, filed Apr. 30, 2002; U.S. patent Ser. No. 60/376,655, filed Apr. 30,2002; and U.S. patent application Ser. No. 10/135,180 filed Apr. 30,2002, which is a continuation-in-part of copending U.S. patent application Ser. No. 10/059,929 filed Jan. 29, 2002, and incorporates such applications herein by reference.

Additionally, the present application is being filed concurrently with and incorporates by reference the following applications: “Automated Messaging Center System and Method For Use With A Healthcare System” (Attorney Docket No. EIS-5849 (1417G P 749)), Ser. No. ______; “System And Method For Obtaining Information From A Bar Code For Use With A Healthcare System” (Attorney Docket No. EIS-5897 (1417G P 754)), Ser. No. ______; “Infusion Therapy Bar Coding System and Method” (Attorney Docket No. EIS-5850 (01417GP0750)), Ser. No. ______; “System and Method for Providing Multiple Units of Measurement” (Attorney Docket No. EIS-5851(1417GP0751)), Ser. No. ______; “Nursing Order Workflow System and Method” (Attorney Docket No. EIS-5899(1417GP0756)), Ser. No. ______; “Biometric Security For Access To A Storage Device For A Healthcare Facility” (Attorney Docket No. EIS-5847(1417G-P720)), Ser. No. ______; “Storage Device For Health Care Facility” (Attorney Docket No. EIS-5848(1417G P 747)), Ser. No. ______; “System And Method For Supporting Clinical Decisions During Patient Care And Treatment” (Attorney Docket No. EIS-5896(1417G-P753)), Ser. No. ______; “System And Method For Facilitating Patient Care And Treatment” (Attorney Docket No. EIS-5898(1417G-P755)), Ser. No. ______; “System And Method For Facilitating Orders During Patient Care And Treatment” (Attorney Docket No. EIS-5900(1417G-P757)), Ser. No. ______; and, “Pharmacy System And Method” (Attorney Docket No. EIS-5901(1417G-P758)), Ser. No. ______

### TECHNICAL FIELD

The present invention is generally directed to a system and method of managing healthcare database records of one or more processors on a network, particularly the synchronization, purging and on-line archiving of the records.

### BACKGROUND OF THE INVENTION

Maintaining healthcare information electronically has been a recent trend for healthcare providers. Healthcare information can be stored in a relational database of a computer. The performance of any relational database can diminish if it is allowed to grow indefinitely large. The point at which performance could be unacceptable depends highly on the structure of the database and the nature of the code operating on the database.

Database system optimization entails choosing efficient ways to initiate a database query or update. Queries and updates can include searching, modifying, organizing, retrieving, adding, and/or deleting information from the database. Database query and update actions are traditionally executed by submitting commands to a server in a database query language. One common database query language is Structured Query Language (“SQL”). As an explanation only, and not a limitation, the following description is made with specific references to database statements using SQL.

SQL is a database query language that was adopted as an industry standard in 1986. SQL is used to communicate with a database. SQL is the standard language for relational database management systems, according to the ANSI (American National Standards Institute). SQL statements are used to perform tasks such as retrieving data from a database or updating data on a database. Common relational database management systems using SQL are: Microsoft SQL Server, Oracle, Sybase, Access, Ingres, and several others. Many database systems use SQL, however, most have additional proprietary extensions used only on their system. Standard SQL commands such as “Select”, “Insert”, “Update”, “Delete”, “Create”, and “Drop” can be used to achieve most anything relating to a database.

A relational database system contains at least one object called a table. The data of the database is stored in these tables. Tables are uniquely identified by table names and are made up of columns and rows. Columns are defined by the name of the column, the data type, and other attributes for the column. Rows contain the records or data of the columns.

A database query language statement (e.g., an SQL statement) is executed by the database system performing steps involving the query or update of data from several database structures, including records, indexes and tables. Often, there exist various methods of running an SQL statement. In one alternative, an SQL statement can be executed in different ways by changing the order that tables and indexes are accessed when executing a statement. The specific combination and order of steps used to run an SQL statement can drastically change the speed or efficiency of execution for the statement. The size of the database being manipulated also effects the speed of compilation of a command.

The select statement is used to query the database and retrieve selected data that match the criteria that is specified. The column names that follow the “select” keyword determine which columns will be displayed in the results. Multiple column names can be requested or an “*” can be used to wildcard select all columns. The table names following the keyword “from” specify tables to be queried and results to be retrieved. Based on the criteria described after the keyword “where”, the where clause is optional and specifies which data values or rows will be returned or displayed. Conditional selections used in the where clause include Equal, Greater than, Less than, Greater than or equal to, Less than or equal to, Not equal to, and Like. “Like”, a pattern matching operator, can conditionally select data of the where clause. Like is a useful operator that allows the selection only of rows that are “like” what is specified. The percent sign “%” can be used to wildcard match characters appearing before or after the characters specified.

Creating a new table requires the keywords “create table” followed by the table name, followed by an open parenthesis, followed by the first column name, followed by the data type for that column, followed by any optional constraints, and followed by a closing parenthesis. It is important to use an open parenthesis before the beginning of the table and a close parenthesis after the end of the last column definition. Each column definition must be separated by a comma and all SQL statements end with a “;”.

SQL database table and column names must start with a letter, but can be followed by up to a total of 30 letters, numbers, or underscore characters. SQL reserved keywords cannot be used as names for tables or column names. Data types specify the type of data in a particular column. If the column “Name” is used to hold names, the column should have a “varchar” (variable-length character) data type.

Records can be inserted into a table by entering the key words “insert into” followed by the table name, followed by an open parenthesis, followed by a list of column names separated by commas, followed by a closing parenthesis, followed by the keyword values, followed by the list of values enclosed in parenthesis. Values entered will be stored in the rows and match the column names specified. Strings are enclosed in single quotes and numbers are not.

The update statement is used to change or update records matching a specified criteria, by constructing a where clause. The delete statement deletes records or rows from the table. The “delete from” command followed by the table name, followed by the where clause which contains the conditions to delete, deletes an entire record/row from a table. Leaving off the where clause causes all records to be deleted. To delete an entire table including all of its rows, the drop table command can be followed by the table name. The drop table command is different than deleting all of the records in the table. Deleting all of the records in the table preserves the table's column and constraint information. Dropping the table removes the table definition and all of its rows.

There is a price associated with the execution of an SQL command. The cost of an execution plan can be measured by the resources consumed to execute the SQL statement. The price of a command execution can be expressed in units of I/O usage, memory usage, network usage, CPU usage, or a combination of these units.

An “optimizer” is used to determine the most efficient execution of an SQL statement, typically based on the cost of resources. The cost is then estimated for each execution's data distribution and storage characteristics or other criteria. The optimizer then compares relative costs of the execution to minimize cost. The cost of an SQL execution can be readily estimated. An example of a cost calculation of a command execution that uses an index to execute the SQL statement follows:

COST=(selectivity)*(cost of access for a single row)*(number of rows in a table)+(cost of index access).

An example of a cost calculation for a command execution performing a full table scan follows:

COST=(number of rows in a table)*(cost of access for a single row of table).

An optimizer can make a determination as to which of these execution plans is preferred.

Using these methods to estimate costs and optimize database manipulation, it should be apparent that searching a smaller table is more efficient and less costly. Creating smaller tables, however, can exclude valuable data in exchange for optimization.

Another problem with database manipulation is how to manage outdated records. Old data in the database can have a detrimental effect on the efficiency of the system. When data that once had informative value becomes obsolete, it creates inefficiencies, particularly when parsing the now useless information. There are a number of tables in the database for which there is no value in retaining the data indefinitely. For example, once certain message types have been processed, it is unlikely that several actual packets and parsed messages will be needed a month after processing. There is some value in retaining the information for a few days, if, for example, it becomes necessary to debug an inconsistency between the source system, the interface engine, and the target systems. From another perspective, purging all data older than a specific date creates system problems, as well. Database records, despite being aged, can be highly valuable. Deleting the information could destroy information necessary in the future. Therefore, a balance between saving and purging old data is desired.

Yet another problem arising from the management of databases is network communication. Multiple computers often share the common information from their databases, particularly over a communication network. When databases are shared, the computers rely on having updated information in their local database memory. Recent modifications to a first database may require access to that data by another database connected to the same network. These network concerns are especially applicable to healthcare facilities. Hospitals seek to provide a secure environment for remote medication storage, but also desire access to the medication storage irrespective of the network communication link to the remote computer and its database.

Generally, drawbacks of previous systems were intensive labor and time requirements as well as the reduced security of the controlled substances while they are at the remote locations. The remote storage locations create a need for central control over a network for the storage depots. The control over remote locations is further complicated by a desire for constant, or at least consistent, periodic communication through a network to a central processor.

System access and control are also critical to many users. As a result, many facilities use a clustered network configuration to guard against the system's network server failures. In some cases, wide area network links controlled by a third party are implemented and can have temporary or chronic network problems. It is rare to find a site that never experiences any network problems. In prior practice, medication depots would either always operate offline, leaving the online data out of date until the time of synchronization or only operate online, in which case the procedures for offline use would provide only limited functionality and may not capture all of the information needed for the clinical profile of the patient and billing.

The present invention is provided to solve these and other problems.

### SUMMARY OF THE INVENTION

The present invention is generally directed to a system and method of managing the healthcare database records of one or more processors on a network, particularly the synchronization, purging and on-line archiving of the records.

In one embodiment, the invention comprises database management as it relates to the purging and archiving of database records. For the transactional data where performance is important, the present invention avoids degradation in performance by providing the means for limiting the size of the active database. The technique used is to provide automatic procedures for purging unnecessary data from the database and archiving inactive data to two or more archive databases, still available on-line, without affecting the transactional performance. The present invention also automatically retrieves data from the archive databases and returns it to the active database when the data becomes active again. All database access is transparent to the user as if there is only a single database.

Large-scale reports are run against the archive databases so they will have no impact on the transactional performance. By using two or more archive databases, most large-scale reports can also run more efficiently if they require only the more recent data, since they will be running against a smaller database rather than the full historical data in the second or final level of archive.

To provide customer control of system operation, the purging and archiving operations are highly configurable by information technology staff at the installation site, with little to no programming changes required. Tables such as this can be automatically purged on a regularly scheduled basis to retain only the most recent data. The healthcare facility defines the purge schedule and the amount of data to be retained in a few broad groups of tables.

There are a number of tables in the database where some of the data is not actively used. For example, a patient may not have been present in the healthcare facility for several years after having a series of encounters and a large number of prescriptions, administrations, monitoring parameters and diagnostic tests. The associated data can be retained for legal and research purposes and in case the patient returns. Leaving the data in the active database, however, could adversely impact transactional performance; therefore, this data needs to be archived. An active healthcare record database contains active healthcare data records which are records that are currently active or have been inactive for a period less than the user defined data retention period.

In another embodiment of the present invention, two or more levels of archiving can be provided. Deletion from the active database after data has been archived is based on healthcare facility rules defining how long a patient's records are retained in the active database subsequent to inactivity. Data is retained in the active database so long as the data is in active use and for a user definable retention period thereafter. Rules are similarly defined for different groups of non-patient data.

Deletion from the first level archive database after data has been archived to the second level archive is based on healthcare facility rules defining how long data should be retained in the first level archive after information has become inactive. The archiving operation can be scheduled nightly by the healthcare facility, when database activities tend to be minimal. The execution of a database archive proceeds with no need to shut down the database. It performs the following steps:

All data new or modified for all tables not in a purge group is copied from the active database to the Level one and Level two archives. There is more than one database copy of the active data.

If the first step had no errors, the archive operation goes through all of the inactive rows in the archivable tables of the active database and the Level one archive database and deletes any rows that have passed the retention period defined by the healthcare facility, also deleting rows to be purged from the other tables. The space from the deleted rows is deallocated and coalesced, and indexes are rebuilt to maintain peak optimized performance. Reports that require up-to-the-minute data and that only cover a time period within the retention periods for the tables used are executed against the active database.

Reports that require up-to-the-minute data and that cover a time period beyond the retention period notify the user that the archive process will be run first and then run against either the Level one archive or the Level two archive, depending on the requested time period. The retention period for the Level one archive is chosen so that most reports can run against it, traditionally a 366-day period. Large-scale reports requiring more historical data are run against the Level two archive. Similarly, the Level one archive and the Level two archive can be supplemented by additional archive databases. These extra databases can be structured based on the reporting needs of the healthcare facility to create an environment where smaller subgroups of data can be manipulated for efficient operation.

In still another aspect of the invention, the system is programmed to periodically synchronize the database of the local depot computer with the database of the central processor. The database information changes entered at either location are updated at the other database each time system synchronization is scheduled. The information changed, at either site, since the last system synchronization, is transferred to the other computer over the network communication link. The database of the depot computer contains a subset of the data in the central database that is specific to the operations, contents, and location of the medical storage depot.

In still another aspect of the invention, the user has access to the most up-to-date information that is locally available. In order for this to happen, changes in user authentication and in the patient and inventory data for the particular depot are automatically downloaded to the depot periodically so the user has access to recent information. If the user needs to remove drugs for a patient who has arrived on the nursing unit after the most recent update before the network connection was lost, then the user has the capability to enter the encounter locator and patient name for temporary storage.

In still another aspect of the invention, the system is designed to automatically reconnect when network connection is restored after it goes down or there is some other interruption in service. Also, even with the network down, the user can use a database local to the depot to continue to operate the system. The depot captures the information locally and when the network connection is restored, sends the data to the server so it can be stored just as if the network connection was never dropped.

In still another aspect of the invention, when a database modification causes an error that is discovered upon synchronization, the user is notified to correct the information before the upload is allowed. The user can correct the erroneous data so that it can upload correctly, or clear it if the correct information has been entered by another means.

Other features and advantages of the invention will be apparent from the following specification taken in conjunction with the following drawings. Further aspects of the invention are disclosed in the detailed description of the preferred embodiment, the drawings and the claims.

### BRIEF DESCRIPTION OF THE DRAWINGS

FIG. 1 is a block diagram of an embodiment of a medical depot network having healthcare databases of the present invention; and

FIG. 2 is a simplified block diagram of a local area network connected to the medical depot network of FIG. 1.

### DETAILED DESCRIPTION OF THE PREFERRED EMBODIMENT

While this invention is susceptible to embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Poor logical database design results in bad physical database design, and generally results in poor database performance. A database designed from scratch requires the necessary time and effort to achieve the proper logical database design. Once the logical design is correct, the physical design requires additional effort. Both the logical and physical design must be properly configured to optimize the performance out of the database. When logical designs are incorrect before development of the application, alterations after the application implementation are difficult. Fast, expensive hardware can rarely overcome the poor performance caused by a bad logical database design.

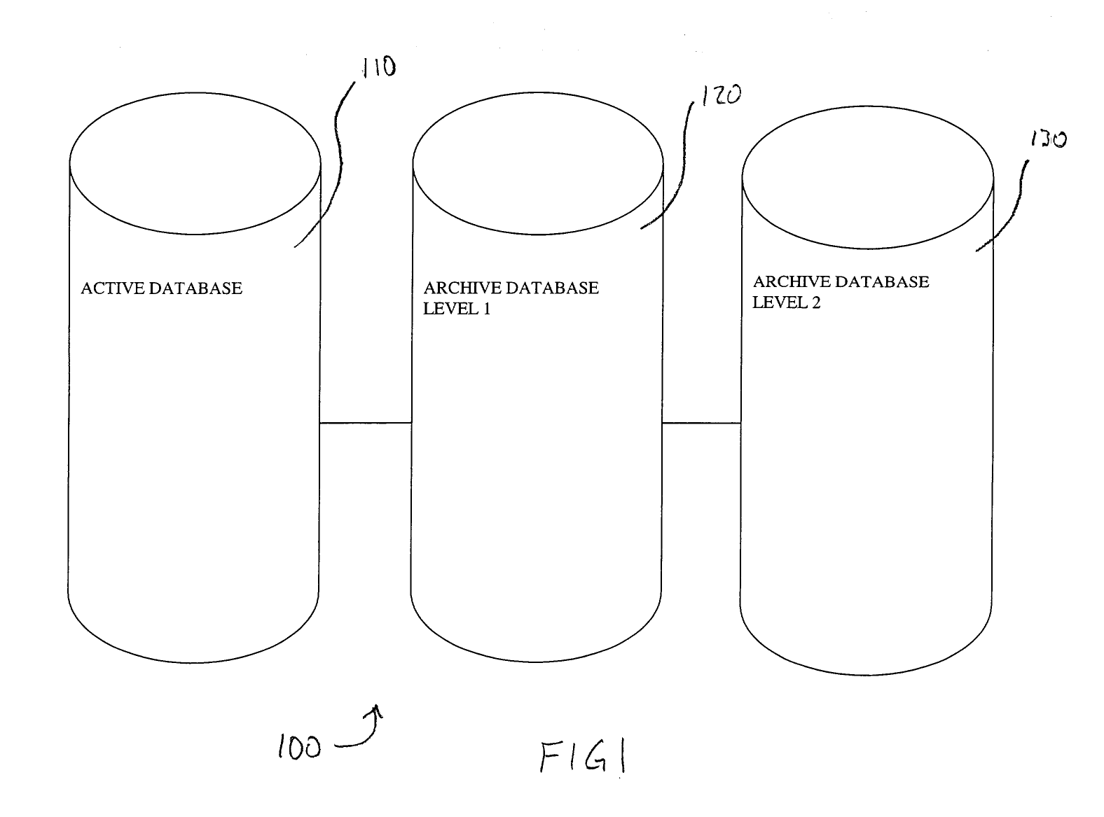

FIG. 1 discloses multi-level storage and purging in a relational database management system with synchronization and offline operation during network failures. Shown is an embodiment of the database management process for archiving and purging healthcare and related information. Specifically, FIG. 1 discloses a medical depot network 100 having an active database 110, a Level one archive database 120, and a Level two archive database 130. For the scalability of databases, most healthcare facilities can retain the two archive databases 120, 130 on the same server as the active database 110 with adequate performance. The processes for the archive databases 120, 130 run at a lower priority than the processes for the active database 110. For large amounts of data that is accessed frequently, the hospital may elect to set up additional database servers to eliminate any detrimental impact on transactional activity efficiency. When individual databases reside on their own separate database server, scalability of the healthcare facility system can dramatically improve.

Purging architecture and retention rules are defined for different groups of tables that can be purged. Preferably, the nightly purge/archive task uses the predefined rules to determine which rows can be deleted from the tables. The space from the deleted rows is deallocated and coalesced and the indexes are rebuilt. This same task is used to delete rows that have been archived from the active databases 110 and/or Level one archive 120 after their retention period has passed.

In the archiving architecture, there are three or more databases for the live environment: the active database 110, the Level one archive 120, and the Level two archive 130. Additional levels of archive databases may be added to improve database performance, particularly in higher database levels. Preferably, regular nightly program executions can be scheduled that perform the operations of copying new data to the archives 120, 130 and deleting data from the active database 110 and Level one archive 120. Note that there is some redundancy among the three databases. The active data is stored in all three databases 110, 120, 130 as of the most recent copying job. This permits any report to be executed against a single database. The database selection depends on the time period selected for the report. Each database contains information about when purging and archiving last occurred. There are two programs: purge/archive and purge/archive/viewer.

Purge/archive is an SQL script that: copies all new or modified data for tables that are not in any purge group from the active database 110 to the Level one archive 120 and Level two archive 130 (this part of the script is available to be run separately); deletes data from the active database 110 if it is purge-able and the retention rule says it can be deleted; deletes data from the active database 110 if it has been archived and the retention rule says it can be deleted; deletes data from the Level one archive 120 if the Level one retention rule says it can be deleted; deallocates and coalesces space and rebuilds indexes in all databases; generates logs of its activity, errors, etc.; sends email or messaging alerts in the case of errors. Scheduling is set up using the operating system. Archiving is also called by a report manager, if necessary, so that the reports never need to access more than one database. Note that, after this script runs, the active data is present in all three databases 110, 120, 130.

Purge/archive/viewer runs in a browser and is normally on a client workstation and used to view logs and set configuration parameters. It can also be used to stop and restart the purge/archive generic cluster application and run either an archive script or the purge/archive job.

Management reports and batch reports check the selection criteria compared to the retention periods on the databases and the last archived date/time. If the active database 110 is required, a confirmation dialog box is used to alert the user to the possible performance impact and then the archive program is run so the report can be run against it.

Database tables may or may not be part of an archive group. The archive group comprises a list of tables and database tables may be associated with no more than one archive group. Archive groups have a specific retention period. Each table within a specific archive group has the identical retention period. The retention period defines the period of data inactivity after which the data records of the database table will be archived or purged.

The scheduled copying of active data to archives begins when the Level one archive 120 and Level two archive 130 are created containing a complete copy of the active database 110. The nightly script copies all new or modified data from all tables in the active database 110, other than the tables in a purge group, to both archives. The healthcare facility can define retention periods for archiving and purging separately for a few different groups of tables. The steps to do this are:

Read EVENT_DTT for the most recent DONE_ARCHIVE event from PURGE_ARCHIVE_LOG.

For every row of every table that is not in a purge group, determine if a change has occurred since EVENT_DTT. If there has been no change, do nothing. Otherwise, determine if the row exists in the Level one 120 and/or Level two archive 130.

If it does exist, replace it with the row from the active database 110.

If it does not exist, insert the row from the active database 110.

The date and time that a row has been modified is calculated as the modified_dtt except for the tables below:

| Table | Field(s) to compare to the EVENT_DTT |
|---|---|
| ADDED_MS_ITEM | PROCESSED_DT |
| ADMIN_ROUTE_CODE | MODIFIED_DT |
| BRAND_NAME | MODIFIED_DT |
| CART_FILL_ITEM_HIST | greatest of FILLED_DTT, CREATED_DTT, |
| | CHECKED_DTT, REPORT_BATCH_DTT, |
| | RECONCILED_DTT |
| CHANGED_ITEM | PROCESSED_DT |
| CONTAINER_TRAN | CREATED_DTT |
| DOSAGE_FORM | MODIFIED_DT |
| ENCOUNTER_HIST_PHYS_EXAM | CREATED_DTT |
| ENCOUNTER_PROGRESS | CREATED_DTT |
| ENC_REACTIVATE_HIST | greater of DISCHARGE_DTT, CREATED_DTT |
| HL7_ERROR_LOG | greatest of CREATED_DTT, NOTIFY_DTT, |
| | ACKNOWLEDGE_DTT |
| HL7_EVENT | EVENT_DTT |
| HL7_PACKET | PKT_DTT |
| HL7_TRIGGER | greatest of SEND_DTT, RETURN_DTT, |
| | CREATED_DTT, PROCESSED_DTT |
| HL7_TRIGGER_ERROR | greatest of CREATED_DTT, SEND_DTT, |
| | RETURN_DTT, PROCESSED_DTT |
| INACTIVATED_ITEM | PROCESSED_DT |
| ITEM_AWP | CREATED_DTT |
| ITEM_COUNT_TRAN | greater of TRAN_DTT, BIN_OPENED_DTT |
| ITEM_TRAN | greatest of TRAN_DTT, ASSIGNED_DTT, |
| | CHECKED_DTT, FlLLED_DTT |
| LOGIN_FAILURE | FAILURE_DTT |
| MESSAGE_RECIPIENT | greater of OPEN_DTT, ACTION_COMPLETE_DTT |
| MS_3PTY_REST | MODIFIED_DT |
| MS_ACT_TYPE | MODIFIED_DT |
| MS_CDN_MFG | MODIFIED_DT |
| MS_FORM_TYPE | MODIFIED_DT |
| MS_GENERIC_CODE | MODIFIED_DT |
| MS_INTEXT_CODE | MODIFIED_DT |
| MS_ITEM | MODIFIED_DT |
| MS_ITEM_INCOMPLETE | CREATED_DT |
| MS_MDDB_IMPORT_INFORMA- | MODIFIED_DT |
| TION | |
| MS_RX_OTC_IND | MODIFIED_DT |
| MS_THER_CLASS | MODIFIED_DT |
| NARCOTIC_BIN_TRAN | CREATED_DTT |
| NARCOTIC_LOG | CREATED_DTT |
| ORDER_EVENT | ORDER_EVENT_DTT |
| ORPHANED_ITEM | PROCESSED_DT |
| PACKAGE_DESC | MODIFIED_DT |
| PACKAGE_SIZE_UOM | MODIFIED_DT |
| PROCESS_RESULT | PROCESS_END_DTT |
| RESULT_DETAILS | RESULT_DETAIL_DTT |
| RT_AUDIT | AUDIT_DTT |
| RT_EXPORT_FORMAT | MODIFIED_DT |
| RT_LOGIN | LOGIN_DTT |
| RT_PASSWORD | EFECT_DT |
| RT_REPORT_AUDIT | AUDIT_DTT |
| RT_V_AUDIT | AUDIT_DTT |
| SCAN_ERROR | CREATED_DTT |
| SCHEDULE_CODE | MODIFIED_DT |
| SINGLE_COMBO | MODIFIED_DT |
| SOLUTION_PARAMETERS | EXPIRATION_DT |
| STABILITY | MODIFIED_DT |
| STORAGE_CONDITION | MODIFIED_DT |
| STRENGTH_UOM | MODIFIED_DT |
| SYSTEM_INFORMATION | always replace entire table |
| ITT_VFC_NOTE | CREATED_DTT |
| UNATH_ENCOUNTER | CREATED_DTT |
| UNCONFIRMED_ITEM | PROCESSED_DT |
| WARD_STOCK_COUNT | CREATED_DTT |
| WASTE_RETURN | ADMIN_DTT |
| W_MS_ITEM_INCOMPLETE | CREATED_DT |
| ACTION | always replace entire table |
| ATT_COLOR | always replace entire table |
| AUTROS_RT_GROUP | always replace entire table |
| BARCODE_TYPE | always replace entire table |
| DISPLAY_MODE | always replace entire table |
| GPI_DRUG_NAME | insert or replace if the corresponding MS_ITEM row is |
| | being inserted or replaced |
| HL7_ABNORMAL_TEST_NATURE | always replace entire table |
| HL7_ADMIN_SITE | always replace entire table |
| HL7_DIAG_SERVICE | always replace entire table |
| HL7_DIET_SPEC_TYPE | always replace entire table |
| HL7_ORDER_CONTROL | always replace entire table |
| HL7_ORDER_RESPONSE_FLAG | always replace entire table |
| HL7_ORDER_RESULT_STATUS | always replace entire table |
| HL7_ORDER_STATUS | always replace entire table |
| HL7_REPEAT_INTERVAL | always replace entire table |
| HL7_SPECIMEN_ACTION | always replace entire table |
| HL7_SPECIMEN_SOURCE | always replace entire table |
| HL7_TEST_NATURE | always replace entire table |
| HL7_TRANSPORTATION_MODE | always replace entire table |
| HL7_VALUE_TYPE | always replace entire table |
| ITEM_TRAN_TYPE | always replace entire table |
| MENU | always replace entire table |
| MENU_CLASS | always replace entire table |
| MENU_ITEM | always replace entire table |
| MENU_ITEM_TYPE | always replace entire table |
| MSSAGE_FOLDER | always replace entire table |
| MESSAGE_PRIORITY | always replace entire table |
| NARCOTIC_OPENED_BIN_ITEM | insert or replace if the corresponding |
| | NATCOTIC_BIN_TRAN is to be inserted or replaced |
| ONL_SUPPLY | insert or replace if the corresponding RX row is being |
| | inserted or replaced |
| ORDER_SET_ORDER_TEMPLATE | insert or replace if the corresponding order_set is being |
| | inserted or replaced |
| ORDER_TEMPLATE | insert or replace if the corresponding |
| | order_set_order_template is being inserted or replaced |
| PAR_LOOKUP | always replace entire table |
| PLAN_TABLE | TIMESTAMP |
| RT_ACCESS | always replace entire table |
| RT_ADMIN_USER | always replace entire table |
| RT_COLUMNS | always replace entire table |
| RT_CONSTRAINTS | always replace entire table |
| RT_DEFAULT_DEFINES | always replace entire table |
| RT_DISPLAY_STYLE | always replace entire table |
| RT_DISPLAY_STYLE_CLASS | always replace entire table |
| RT_ERROR | always replace entire table |
| RT_EVENT | always replace entire table |
| RT_EVENT_CONTACT | always replace entire table |
| RT_GROUP | always replace entire table |
| RT_GROUP_REPORTS | always replace entire table |
| RT_GROUP_USER | always replace entire table |
| RT_GRPREP_COLUMNS | always replace entire table |
| RT_GRPREP_GRAPH | always replace entire table |
| RT_REPORTS | always replace entire table |
| RT_REPORT_HEADER | always replace entire table |
| RT_REPORT_HEADER_CONTENTS | always replace entire table |
| RT_SC_CONSTRAINTS | always replace entire table |
| RT_SC_FEEDBACK | always replace entire table |
| RT_SC_INDEXES | always replace entire table |
| RT_SC_SOURCE | always replace entire table |
| RT_SC_TABLES | always replace entire table |
| RT_SC_SYSTEM | always replace entire table |
| RT_SYSTEM_CONTACT | always replace entire table |
| RT_TABLES | always replace entire table |
| RT_UPGRADE_COMMANDS | always replace entire table |
| RT_UPGRADE_STATUS | always replace entire table |
| RT_USER_CONFIGURATION | insert or replace if the corresponding RT_USER is being |
| | inserted or replace |
| RT_USER_QUERY_SET | insert or replace if the corresponding RT_USER is being |
| | inserted or replaced |
| RT_USER_QUERY_SET_VALUE | insert or replace if the corresponding |
| | RT_USER_QUERY_SET is being inserted or replaced |
| RX_STATUS | always replace entire table |
| RX_TYPE | always replace entire table |
| SCAN_ERROR_TYPE | always replace entire table |
| SCREEN | always replace entire table |
| SOURCE_APPLICATION | always replace entire table |
| S_MS_ITEM | always replace entire table |
| TEST_HIERARCHY | insert or replace if the corresponding |
| | TEST_HIERARCHY is being inserted or replaced |

Archiving groups and rules are implemented by the healthcare facility. The hospital can define retention periods for archiving separately for a few different groups of tables. Copying archive data back to the active database 110 is completed using the archive retention groups and rules for retrieving archived data into the active database 110:

| Archive Retention | |
|---|---|
| Group | Rule for Retrieving into the Active Database 110 from an Archive |
| Audit (Priority 2) | Only used for reporting. Never copy from the archives back to the active |
| | database 110. |
| Lot (Prionty 4) | Only used for reporting. Never copy from the archives back to the active |
| | database 110. Rules for lot history archiving will need to be adjusted in |
| | the future when we have full lot tracking. |
| Narcotics (Priority 3) | Only used for reporting. Never copy from the archives back to the active |
| | database 110. |
| Patient (priority 1) | In the ADT interface for any message, if a patient id comes across that is |
| | not in the active database 110 look in the Level one archive 120. If it is |
| | not in the Level one archive 120, look in the Level two archive 130. |
| | When the patient is found in an archive, copy all data for that patient to |
| | the active database 110 and set the active_dtt on the row in the patient |
| | table to sysdate. In the main application, on the find patient screen, if the |
| | selection criteria include patients discharged prior to the retention period, |
| | include the Level one 120 or two 130 database in the search depending on |
| | the Level one 120 retention. If a patient is selected for further processing |
| | who was not in the active database 110, then copy all data for the patient |
| | to the active database 110 and set the active_dtt to sysdate. |
| Non_patient_ | In the main application, when a user is retrieving messages, if the |
| messages (Priority 4) | selection criteria include messages prior to the retention period, then |
| | search all levels of archive that could contain the messages based on their |
| | own retention periods, and copy those messages to the active database |
| | 110, setting the active_dtt to sysdate. |

Deleting Data from the Active Database 110 After It Has Been Archived

The exact rule used to determine if a row should be deleted after archiving depends on the particular table as follows:

| | Archive | |
|---|---|---|
| | Retention | |
| Archivable Table | Group | Deletion Rule |
| ITEM_HIST | audit | (Sysdate - item_hist_created_dtt) > |
| | | audit_retention_days |
| RT_AUDIT | audit | (Sysdate - audit_dtt) > audit_retention_days |
| SCAN_ERROR | audit | (Sysdate - created_dtt) > audit_retention_days |
| BIN_ITEM_LOT | lot | (sysdate - modified dtt) > lot_retention_days |
| | | and current_uct = 0 |
| CART_FILL | lot | future - for now follow purge logic |
| CART_FILL_ITEM | lot | future - for now follow purge logic |
| CART_FILL_ITEM_HIST | lot | future - for now follow purge logic |
| CART_FILL_ITEM_HIST_LOT | lot | Delete cart_fill_item_hist_lot cfihl where |
| | | (sysdate - cfihl.modified_dtt) > |
| | | lot_retention_days and exists (select cf.status |
| | | from cart_fill cf, cart_fill_item cfi, |
| | | cart_fill_item_hist cfih where |
| | | cfih.cart_fill_item_hist_id = |
| | | cfihl.cart_fill_item_hist_id and |
| | | cfi.cart_fill_item_id = cfih.cart_fill_item_id |
| | | and cf.cart_fill_id = cfi.cart fill_id and |
| | | cf.status = ‘Reconciled’) |
| CART_FILL_ITEM_LOT | lot | Delete cart_fill_item_lot cfil where (sysdate - |
| | | cfil.modified_dtt) > lot_retention_days and |
| | | exists (select cf.status from cart_fill cf, |
| | | cart_fill_item cfi where cfi.cart_fill_item_id = |
| | | cfil.cart_fill_item_id and cf.cart_fill_id = |
| | | cfi.cart_fill_id and cf.status = ‘Reconciled’) |
| ITEM_LOT | lot | Active_yn = ‘N’ and (sysdate - modified_dtt) |
| | | > lot_retention_days |
| PH_ITEM_LOT | lot | On_hand_qty = 0 and (sysdate - modified_dtt) |
| | | > lot_retention_days |
| PH_ITEM_PREMIX | lot | On_hand_qty = 0 and (sysdate - modified_dtt) |
| | | > lot_retention_days |
| PREMIX_ITEM_LOT | lot | Delete if corresponding ph_item_premix is |
| | | deleted |
| REQUISITIONS_LOT | lot | (sysdate - modified_dtt) > lot_retention_days |
| WARD_STOCK_LOT | lot | (sysdate - modified_dtt) > lot_retention_days |
| NARCOTIC_BIN_TRAN | narcotics | (sysdate - created_dtt) > |
| | | narcotics_retention_days |
| NARCOTIC_LOG | narcotics | (sysdate - created_dtt) > |
| | | narcotics_rentention_days |
| NARCOTIC_OPENED_BIN_ITEM | narcotics | Delete when corresponding narcotic_bin_tran |
| | | is deleted |
| ADR | patient | Delete when corresponding patient row is |
| | | deleted |
| ADR_DRUG_THERAPY | patient | Delete when corresponding patient row is |
| | | deleted |
| ADR_SUSPECTED_RX | patient | Delete when corresponding patient row is |
| | | deleted |
| ALLERGY_PROFILE | patient | Delete when corresponding patient row is |
| | | deleted |
| DISEASE_PROFILE | patient | Delete when corresponding patient row is |
| | | deleted |
| ENCOUNTER | patient | Delete when corresponding patient row is |
| | | deleted |
| ENCOUNTER_EXTERNAL_RX | patient | Delete when corresponding patient row is |
| | | deleted |
| ENCOUNTER_HEIGHT | patient | Delete when corresponding patient row is |
| | | deleted |
| ENCOUNTER_HIST_PHYS_EXAM | patient | Delete when corresponding patient row is |
| | | deleted |
| ENCOUNTER_ONL | patient | Delete when corresponding patient row is |
| | | deleted |
| ENCOUNTER_PROGRESS | patient | Delete when corresponding patient row is |
| | | deleted |
| ENCOUNTER_WEIGHT | patient | Delete when corresponding patient row is |
| | | deleted |
| ENCTR_PATIENT_CLASS_HIST | patient | Delete when corresponding patient row is |
| | | deleted |
| ENC_DISEASE_PROFILE | patient | Delete when corresponding patient row is |
| | | deleted |
| ENC_REACTIVATE_HIST | patient | Delete when corresponding patient row is |
| | | deleted |
| ITEM_ADMIN_TRAN | patient | Delete when corresponding patient row is |
| | | deleted |
| ITEM_ADMIN_TRAN_BILLING | patient | Delete when corresponding patient row is |
| | | deleted |
| ITEM_ADMIN_TRAN_OTHER | patient | Delete when corresponding patient row is |
| | | deleted |
| ITEM_ALLERGY_PROFILE | patient | Delete when corresponding patient row is |
| | | deleted |
| LAB_ORDER | patient | Delete when corresponding patient row is |
| | | deleted |
| LAB_RESULT | patient | Delete when corresponding patient row is |
| | | deleted |
| LAB_RESULT_NOTES | patient | Delete when corresponding patient row is |
| | | deleted |
| MONITORING_RESULTS | patient | Delete when corresponding patient row is |
| | | deleted |
| MONITORING_RESULTS_VALUE | patient | Delete when corresponding patient row is |
| | | deleted |
| ONL_SUPPLY | patient | Delete when corresponding patient row is |
| | | deleted |
| OUTPATIENT_RX | patient | Delete when corresponding patient row is |
| | | deleted |
| PATIENT | patient | Delete when (sysdate - active_dtt) > |
| | | patient_retention_days, see note below about |
| | | how active_dtt is set |
| PATIENT_ALLERGY_PROFILE | patient | Delete when corresponding patient row is |
| | | deleted |
| PERSONNEL_ITEM | patient | Delete when corresponding patient row is |
| | | deleted |
| RX | patient | Delete when corresponding patient row is |
| | | deleted |
| RX_ITEM | patient | Delete when corresponding patient row is |
| | | deleted |
| RX_PERIOD | patient | Delete when corresponding patient row is |
| | | deleted |
| RX_SCHEDULE | patient | Delete when corresponding patient row is |
| | | deleted |
| RX_SCHEDULE_ITEM | patient | Delete when corresponding patient row is |
| | | deleted |
| RX_SCHEDULE_ITEM_PRE- | patient | Delete when corresponding patient row is |
| PARED | | deleted |
| RX_SCHEDULE_PREPARED | patient | Delete when corresponding patient row is |
| | | deleted |
| SCHEDULED_TESTS | patient | Delete when corresponding patient row is |
| | | deleted |
| SELF_MED | patient | Delete when corresponding patient row is |
| | | deleted |
| UNATH_ENCOUNTER | patient | Delete when corresponding patient row is |
| | | deleted |
| WASTE_RETURN | patient | Delete when corresponding patient row is |
| | | deleted |
| MESSAGE_BODY | patient, | For patient messages, Delete when |
| | non_patient_ | corresponding patient row is deleted. For |
| | messages | non-patient messages (i.e. encounter_id is |
| | | null), delete when (sysdate - active_dtt) > |
| | | message_retention_days |
| MESSAGE_RECIPIENT | patient, | Delete when the corresponding |
| | non_patient_ | Message_body row is deleted |
| | messages | |

The active_dtt field of the patient record is set as follows:

There is a trigger on inserts and updates to the patient table in the active database 110 that always sets active_dtt to sysdate. The active healthcare record database contains active healthcare data records which are records that are currently active or have been inactive for a period less than the user defined data retention period. The nightly PurgeArchive program looks at every patient in the active database 110 and performs the following steps in sequence for the active database 110:

If the patient has any active encounter, the active_dtt is set to sysdate, otherwise:

If (sysdate—active_dtt)<=patient_retention₁₃ days then no action is taken, otherwise:

The process looks at every row of all of the tables in the patient group until it finds a modified_dtt that is greater than the active_dtt on the corresponding row of the patient table. When it does, it sets the active_dtt for the patient row to the modified_dtt. If the table does not have a modified_dtt, then the created_dtt is used.

If none of the rows has been modified since the last active_dtt, then it is left unchanged and all rows of all tables for the patient are deleted.

The rules for deleting data from the Level one archive 120 apply to deletion from the active database 110. Deletion from the Level one archive 120 uses the same rules, but there is only one retention period used (for example 366 days).

Purging Groups and Rules

The hospital can define retention periods for purging separately for a few different groups of tables.

The exact rule used to determine if a row can be deleted depends on the particular table.

The purging retention groups are:

HL7 (Priority 1)

Inventory (Priority 2)

Shift (Priority 3)

Login Failures (Priority 4)

Activity Logs (Priority 5)

The rules are:

| | Purging | |
|---|---|---|
| | Retention | |
| Table Name | Group | Purging Rule |
| HL7_ERROR_LOG | HL7 | delete_flag_YN = ‘Y’ and (sysdate - created_dtt) > |
| | | hl7_retention_days) |
| HL7_EVENT | HL7 | cleared_yn = ‘Y’ and (sysdate - event_dtt) > |
| | | hl7_retention_days |
| HL7_MSG_DATA | HL7 | if (MSG_IN_OUT_ID != ‘O’ or msg_trigger_event_id |
| | | != ‘P03’ or msg_type_id != ‘DFT’) and processed_dtt not |
| | | null (see also rules for item_admin_tran_billing) |
| HL7_PACKET | HL7 | Delete when the corresponding HL7_EVENT is deleted |
| item_admin_tran_other, | HL7 | if item_admin_tran_billing row has hl7_msg_data_id > |
| item_admin_tran_billing, | | 0 then if the corresponding row in hl7_msg_data table |
| HL7_msg_data | | has processed_dtt not null and (sysdate - processed_dtt) |
| | | > hl7_retention days then delete the row in |
| | | item_admin_tran_billing and the corresponding rows in |
| | | item_admin_tran_other and hl7_msg_data |
| HL7_TRIGGER | HL7 | processed_dtt not null |
| BIN_ITEM_TRAN | inventory | (sysdate - modified_dtt) > inventory_retention_days |
| CART_FILL | inventory | (sysdate - max(modified_dtt, end_dtt, exchanged_dtt)) > |
| | | inventory_retention_days and status = RECONCILED |
| CART_FILL_ITEM | inventory | Deleted when corresponding cart_fill row is deleted |
| CART_FILL_ITEM_HIST | inventory | Deleted when corresponding cart_fill row is deleted |
| CONTAINER_TRAN | inventory | (sysdate - created_dtt) > inventory_retention_days or |
| | | ((rx_schedule_id not null) and (rx_schedule_id not in |
| | | database)) (do patient archive first) |
| ITEM_COUNT_TRAN | inventory | (sysdate - tran_dtt) > inventory_retention_days or |
| | | ((encounter_id not null) and (encounter_id not in |
| | | database)) (do patient archive first) |
| ITEM_TRAN | inventory | (sysdate - tran_dtt) > inventory_retention_days or |
| | | ((encounter_id not null) and (encounter_id not in |
| | | database)) (do patient archive first) |
| PH_ITEM_INVENT_TRANS | inventory | (sysdate - transaction_dtt) > inventory_retention_days |
| PH_ITEM_PREMIX | inventory | item_lot_id is null and (sysdate - modified_dtt) > |
| | | inventory_retention_days |
| REQUISITIONS | inventory | (sysdate - modified_dtt) > inventory_retention_days |
| SUPPLY_TRAN | inventory | (sysdate - modified_dtt) > inventory_retention_days or |
| | | ((encounter_id not null) and (encounter_id not in |
| | | database)) (do patient archive first) |
| LOGIN_FAILURE | login | (sysdate - failure_dtt) > login_failure_retention_days |
| | failures | |
| SHIFT | Shifts | (sysdate - stop_dtt) > shift_retention_days |
| SHIFT_ENCOUNTER | Shifts | (sysdate - stop_dtt) > shift_retention_days or |
| | | ((encounter_id not null) and (encounter id not in |
| | | database)) (do patient archive first) |
| PURGE_ARCHIVE_LOG | Activity | (sysdate - modified_dtt) > activity_log_retention_days |
| | Logs | |

Database Objects

New Tables

Purge Archive Information Table

This table is used to store information required for the rules that guide purging and archiving. The columns are:

AUDIT_RETENTION_DAYS—Days to retain rows in the active database 110 for the tables of the audit group.

LOT_RETENTION_DAYS—Days to retain rows in the active database 110 for the tables of the lot group.

NARCOTICS_RETENTION_DAYS—Days to retain rows in the active database 110 for the tables of the narcotics group.

PATIENT_RETENTION_DAYS—Days to retain rows in the active database 110 for the tables of the patient group.

MESSAGE_RETENTION_DAYS—Days to retain rows in the active database 110 for the tables of the message group (except for patient messages).

LEVEL1_RETENTION_DAYS—Days to retain rows in the Level one archive 120 for the tables of all groups.

HL7_RETENTION_DAYS—Days to retain rows in the active database 110 for the tables of the HL7 group.

INVENTORY_RETENTION_DAYS—Days to retain rows in the active database 110 for the tables of the inventory group.

SHIFT_RETENTION_DAYS—Days to retain rows in the active database 110 for the tables of the shift group.

LOGIN_FAILURE_RETENTION_DAYS—Days to retain rows in the active database 110 for the tables of the login-failure group.

ACTIVITY_LOG_RETENTION_DAYS—Days to retain rows in the active database 110 for the tables of the activity_log group.

ALERT_USER_ID—The user to be sent a message whenever an error occurs—may be NULL.

ALERT_EMAIL_ADDRESS_ID—Email address of user to be sent a message through MAPI mail whenever an error occurs—may be NULL.

MODIFIED_BY—User ID of the last user to modify purging and archiving configuration.

MODIFIED_DTT—Date and time of last modification to purging and archiving configuration. Note that pop-ups, audible alarms, and faxes should not be needed since errors in archiving and purging will normally be dealt with the following day and re-run the following night. These errors are less urgent than, for example, errors in ADT processing.

Purge Archive Log Table

This table is used to store a log of purging and archiving activity and messages. It contains the following columns:

EVENT_ID—Unique identifier for the event, from a sequence.

EVENT_DTT—Date and time of the event.

EVENT_TYPE—START_ARCHIVE, DONE_ARCHIVE, ARCHIVE_ERROR, START_PURGE,

DONE_PURGE, PURGE_ERROR where ARCHIVE means the copy process from the active database 110 to the two archives 120, 130 and PURGE means the process of deleting rows from the active 110 and Level one 120 databases and DONE_xxx means completion with no errors.

ERROR_TX—Message text when the event is an error—may be NULL.

RESPONSE_ID—Normally NULL. When an error is generated, a user can select CORRECTED or IGNORE so it does not usually display when viewing the log.

RESPONSE_TX—Text that the user can enter to provide further information.

RESPONSE_BY—User ID of the user entering the response.

RESPONSE_DTT—The data and time the response was entered.

Changes to Existing Tables

Add Column ACTIVE_DTT

The ACTIVE_DTT column must be added to the following tables:

PATIENT

MESSAGE_BODY

User Interface—PurgeArchiveViewer

The PurgeArchiveViewer is a browser-based application to configure purging and archiving, to view logs, and to record responses to errors. It has a single screen split vertically. The left side is used for viewing the log. The right side is used for viewing and modifying the configuration options. There are buttons across the top to perform various control actions.

Top—Control Functions

There are buttons across the top to stop and restart the PurgeArchive generic cluster application and to do a one-time run of either the Archive script or the full Purge/Archive job.

Left Side—Logs

A drop-down list or radio buttons allow the user to select from “Uncleared Errors”, “All Errors”, or “All Events” (defaults to Uncleared Errors). A scrolling box lists all columns of the events in the selected category in reverse chronological order. There is a drop-down list (“Corrected”, or “Ignore”) and a text box where the user can enter optional text to go with the response for the selected event.

Right Side Configuration

This section has 3 panels titled “Archive Retention Periods”, “Purge Retention Periods” and “Notification Options”. The 3 panels simply list the values from the PURGE_ARCHIVE_INFORMATION table and allow the user to modify them.

Changes to the Main Application

Except for various selection screens and some reports, the Main Application always works with the active database 110. If it needs to refer to archived data that is not present in the active database 110, then the data is first moved to the active database 110 (and the active_dtt is updated to sysdate). This copy logic is called from the selection screen if the user selects an archive row for further processing.

In one embodiment, for the Patients screen, if the user selects a row retrieved from an archive for further processing by either double-clicking the row or by highlighting it and clicking either the edit button or profile button, then the logic to copy from the archive is invoked.

The patient selection screen appears when either the “Find Patient” button or Maintain/Patients is used. It populates the data grid in the Patient screen in three different ways, depending on the selection criteria:

If only the Active box is ticked, or the discharged box is ticked but the “Discharged in the last x days” has a value of x<=patient_retention_days, then only the active database 110 is searched.

In another embodiment, if the value of x>patient_retention₁₃ days but<=level 1_retention_days then the active database 110 is searched for matching patients where sysdate—active_dtt<=patient_retention₁₃ days, and the Level one archive 120 is searched for matching patients where sysdate—active_dtt>patient_retention₁₃ days. Before retrieving, the user is warned that the search criteria requires searching the Level one archive 120 and they can click OK or Cancel.

In another embodiment, if the value of x>level 1_retention-days then the active database 110 is searched for matching patients where sysdate—active_dtt<=patient_retention_days, and the Level two archive 130 is searched for matching patients where sysdate—active_dtt>patient_retention₁₃ days. Before retrieving, the user is warned that the search criteria requires searching the Level two archive 130 and they can click OK or Cancel.

If x is null or No Encounters is ticked, then the search works the same way as in condition 3 above.

In another embodiment, the Personal Messages screen is invoked by clicking the Messages button on the main screen. It must be changed to have 3 radio buttons—Active Only, Active+Level one Archive, and Active+Level two Archive. The messages displayed always include the Active messages. If one of the archives is also selected, then the messages from the archive where active_dtt>message_retention_days_days are also displayed.

Reports built into the application should be changed to default to an end date of the EVENT_DTT of the last ARCHIVE_DONE event.

Reports built into the application choose the database to use based on the selection criteria. If the end date in the selection criteria is greater than the EVENT_DTT for the last ARCHIVE_DONE event, then an “Are you sure?” dialog box informs the user that the archive process will need to be run before the report is produced and that it could have an impact on performance. If the user elects to proceed, then the archive process is run before the report.

The report is then run against the Level one Archive database 120 if sysdate—LEVEL1 _RETENTION_DAYS<the start date for the selected time period, otherwise it is run against the Level two archive 130.

Changes to Computerized Physician Order Entries (CPOE)

In another embodiment, except for various selection screens and some reports, CPOE always works with the active database 110. If it needs to refer to archived data that is not present in the active database 110, then the data is first moved to the active database 110 (and the active_dtt is updated to sysdate). This copy logic is called from the selection screen if the user selects an archive row for further processing.

In another embodiment, for the My Patients screen, if the user selects a row retrieved from an archive for further processing by clicking the row, then the logic to copy from the archive is invoked. The advanced search screen needs to be modified to permit the user to specify a “Discharged in the last x days” field that has a user-specific default initially set to three days. The user should also be able to specify a null or “ever” value.

When the patient selection screen appears, it populates the data grid in the Patient screen in three different ways, depending on the selection criteria.

In another embodiment, if the patient status is not specified or only active patients are selected, or the discharged box is ticked but the “Discharged in the last x days” has a value of x<=patient_retention_days, then only the active database 110 is searched.

In another embodiment, if the value of x>patient_retention₁₃ days but<=level1 _retention_days then the active database 110 is searched for matching patients where sysdate—active_dtt<=patient_retention₁₃ days, and the Level one archive 120 is searched for matching patients where sysdate—active_dtt>patient_retention₁₃ days. Before retrieving, the user is warned that the search criteria requires searching the Level one archive 120 and they can click OK or Cancel.

In another embodiment, if the value of x>level1_retention_days then the active database 110 is searched for matching patients where sysdate—active_dtt<=patient retention_days, and the Level two archive 130 is searched for matching patients where sysdate—active_dtt>patient_retention_days. Before retrieving, the user is warned that the search criteria requires searching the Level two archive 130 and they can click OK or Cancel.

In another embodiment, the My Messages screen is invoked by clicking the My Messages button on the main screen. It must be changed to have three radio buttons—Active Only, Active+Level one Archive, and Active+Level two Archive. The messages displayed always include the Active messages. If one of the archives is also selected, then the messages from the archive where active_dtt>message_retention_days are also displayed.

In another embodiment, the Shifts button brings up a selection screen for shifts. This screen should default to a start time between 00:00 yesterday and 23:59 tomorrow.

Management Reports invoked from CPOE should be changed to default to an end date of the EVENT_DTT of the last ARCHIVE_DONE event.

Changes to Management Reports

Management reports should be changed to default to an end date of the EVENT_DTT of the last ARCHIVE_DONE event.

In another embodiment, management reports choose the database to use based on the selection criteria. If the end date in the selection criteria is greater than the EVENT_DTT for the last ARCHIVE_DONE event, then an “Are you sure?” dialog box informs the user that the archive process will need to be run before the report is produced and that it could have an impact on performance. If the user elects to proceed, then the archive process is run before the report.

The report is then run against the Level one Archive database 120 if sysdate—LEVEL1_RETENTION_DAYS<the start date for the selected time period, otherwise it is run against the Level two archive 130.

Changes to Batch Reports

Batch reports choose the database to use based on the selection criteria. If the end date in the selection criteria is greater than the EVENT_DTT for the last ARCHIVE_DONE event, then archive process is run before the report is produced.

In another embodiment, the report is then run against the Level one Archive database 120 if sysdate—LEVEL1_RETENTION_DAYS>the start date for the selected time period, otherwise it is run against the Level two archive 130.

Changes to HL7 Interfaces

There are no changes to outgoing interfaces. For incoming interfaces, the logic is changed when processing PID segments as follows:

If the patient is found in the active database 110, then the processing is unchanged from the current version. Data is retained in the active database so long as the data is in active use and for a user definable retention period thereafter.

In another embodiment, if the patient is not found in the active database 110, then there is a search for the patient in the Level one archive 120. If the patient is found, then all data for that patient from all patient-related tables is copied to the active database and the active_dtt is set to sysdate. When the copy is complete, the processing continues as in the first step.

In another embodiment, if the patient is not found in the Level one archive 120, then there is a search for the patient in the Level two archive 130. If the patient is found, then all data for that patient from all patient-related tables is copied to the active database and the Level one archive 120 and the active_dtt is set to sysdate. When the copy is complete, the processing continues as in the first step.

Except for various selection screens and some reports, the main application preferably works with the active database 110. If it needs to refer to archived data that is not present in the active database 110, then the data is first moved to the active database 110. This copy logic is called from the selection screen if the user selects an archive row for further processing. For the patients screen, if the user selects a row retrieved from an archive for further processing, the logic to copy from the archive is invoked.

An embodiment of the healthcare data record storage system has an active healthcare record database with a plurality of active healthcare data records stored therein. Each of the plurality of active healthcare data record table has a healthcare data record type assigned thereto. The system also has one or more archive healthcare record databases having a plurality of archived healthcare data records stored therein. The system can archive at least one active healthcare data record from the active healthcare record database to the archive healthcare record database as one of the archived healthcare data records. The archiving is based at least in part on the healthcare data record type and at least in part on the period of inactivity of the at least one active healthcare data record. The system is also capable of purging at least one active healthcare data record of the active healthcare record database. Purging can occur after the archived healthcare data record is stored in the archive healthcare record database and can be based at least in part on the healthcare data record type and at least in part on the period of inactivity of the at least one active healthcare data record.

The healthcare data record storage system can archive at least one active healthcare data record from the active healthcare record database to a first or second level archive healthcare record database as one of the first or second level archived healthcare data records based at least in part on the healthcare data record type and at least in part on the period of inactivity of the at least one active healthcare data record. The first level archive healthcare record database can be a subset of the second level archive healthcare record database where the data records are archived for a predetermined period of time prior to being removed from the first level archive healthcare record database. All of the active healthcare data records and first level archive healthcare data records can be archived in the second level archive healthcare record database and possibly never removed from the second level archived healthcare record database.

An embodiment of the active healthcare record database has multiple healthcare data record tables containing the active healthcare data records where each table belongs to zero or one purge and/or archive group. These groups can be but are not limited to audit, lot, narcotics, patient, non-patient messages, inventory, login failures, shifts, HL7 interface information, and activity logs. Groups can be assigned a specific retention period or a predetermined time of inactivity for archiving healthcare data records stored in the respective healthcare data record table.

Archiving can be based on a number of criteria including when a predetermined size of the healthcare data record table has been reached or when a predetermined size of the active healthcare record database has been reached.

The system may use one database server for the active healthcare record database and the same or different database servers for each level of archive of the healthcare record database to increase scalability.

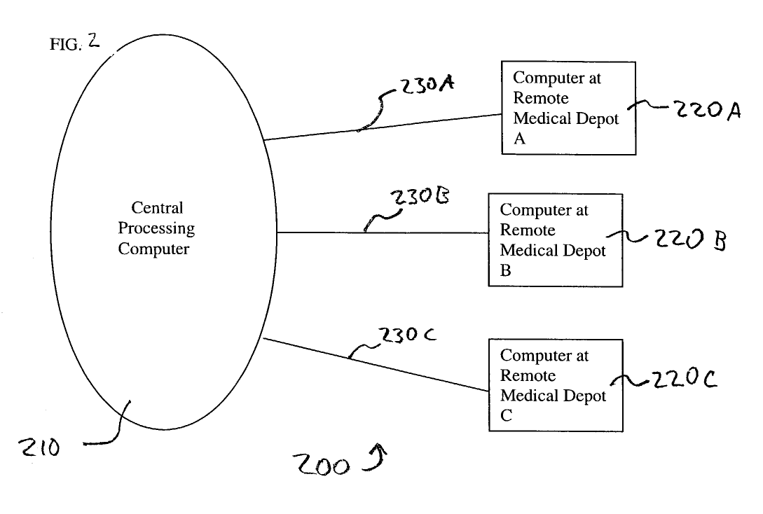

Referring now to FIG. 2, referenced by the number 200, in yet another embodiment, a cart or depot containing secured medical supplies is stationed in a location remote from a system central processing computer. The cart has a local computer 220 with a network communication connection 230 to the system's central processor 210. Both the local computer 220 and the central processor 210 have a database used for access, monitor and control of the medical supply cart. Typically, the local database at the medical supply depot 220 will be a subset of the central database 210. The depot database contains only the information needed for depot functions at the depot location and with the depot's specific inventory. Database updates can be entered at the remote 220 or central 210 location. The updates are then synchronized with the other database over the network 230. Network database synchronization updates are programmed to occur at predefined time intervals so long as the network communication link 230 is working. When the network 230 is active, processes at the depot computer 220 use the data stored at the central computer 210 database.

In yet another embodiment, the remote depot allows user access to the information stored in the computer and the supplies in the medical depot drawers even when the network communication link 230 is broken. The local computer 220 uses the most recent version of its locally stored database information for accessing, monitoring and controlling the medical supply cart. Both the local computer 220 and central processor 210 operate as though the network communication 230 were active. When network connection 230 is reestablished, the local and central databases are synchronized with any information modified at the other location so that both system databases are properly updated.

In yet another embodiment, the database synchronization cycle, prompted by a newly reestablished network communication connection 230 or a regularly scheduled update, can have an entry error. When these entry errors are discovered by the system, the user is prompted to correct the information in the pending upload so that it can be properly uploaded, or clear the error to allow the correct information to be entered by other means.

When running in background mode, the program will: Download into the local user table any active users with a modified date and time since the last download; Download into the local PATIENT and ENCOUNTER tables the relevant columns for any patients and active encounters on the nursing unit that are not already present and delete any of the previous patients that have left the nursing unit; Download into the local tables the rows for the particular depot and nursing unit with a modified date and time since the last download; Insert rows for DownloadStart and DownloadEnd into the central ACTIVATION_LOG table; and, Insert rows for DownloadEnd into the local ACTIVATION_LOG table.

When switching to background mode from foreground mode, the program will: Go through every LOCAL_ACTIVITY row on the local database and use it to generate a corresponding transaction on the central database using the existing logic modified to use the ACTIVITY date and time for the row. As each transaction is completed, the corresponding row is deleted from the LOCAL_ACTIVITY table. For any Quick Med transactions the drug administration transaction will be completed, but if there are any clinical checking messages, they will be sent as high priority patient messages. Go through the ACTIVATION_LOG and copy all data to the corresponding Central table except for duplicates. As each row transaction is completed, the corresponding row is deleted from the local database except for the most recent DownloadEnd row. Insert rows for UploadStart and UploadEnd into the local and central ACTIVATION_LOG table.

If a patient has been added locally then there are 3 possible scenarios: the patient is entered with the correct patient locator and/or encounter locator; the patient is entered with an incorrect patient locator and encounter locator; or, the patient is entered with a system-generated patient locator and encounter locator. For each of these scenarios, the ADT messages for the patient could be received either before or after the upload, but preferably before.

In the first scenario, the RX, RX_ITEM, and ITEM_ADMIN_TRAN rows for the patient need to be inserted into the corresponding tables on the central database. The upload process first attempts to locate the encounter by the locator and matches the name. If the name does not match, the user is prompted to correct the information and the upload for those rows is left pending. If the ADT has already been processed and the encounter exists, then the rows need to be added and linked to that encounter. If the encounter and/or patient records do not exist, then the upload for those rows is left pending. When the ADT message comes across, on the next synchronization cycle, the pending rows will be uploaded.

In the second scenario, a wrong patient or encounter may be located and should fail the name match, so the user will be prompted to correct it and the upload for those rows will be left pending. If no patient and/or encounter is found, then the same action will be taken as was for the first scenario.

In the third scenario the upload routine will again find no match so the uploads will remain pending. In the scenarios such as the latter 2 where there will never be a match for the patient and/or encounter, the uploads will remain pending until the user deals with them. The user will have an on-screen indication that there are still pending uploads. They will able to get into the pending uploads and either correct the patient/encounter information so that it can upload correctly or clear it because the correct information has been entered by other means such as Lifeline or through the main application.

While the specific embodiments have been illustrated and described, numerous modifications can be made to the present invention, as described, by those of ordinary skill in the art without significantly departing from the spirit of the invention. The breadth of protection afforded this invention should be considered to be limited only by the scope of the accompanying claim s.

What is claimed is:

1. A healthcare data record storage system, comprising:
an active healthcare record database having a plurality of active healthcare data records stored therein;
an archive healthcare record database having a plurality of archived healthcare data records stored therein; and,
means for archiving at least one active healthcare data record from the active healthcare record database to the archive healthcare record database as one of the archived healthcare data records, wherein the archiving is based at least in part on a period of inactivity of the at least one active healthcare data record.

2. The healthcare data record storage system of claim 1 further comprising a plurality of archive groups having a retention period for defining the period of inactivity of the at least one active healthcare data record.

3. The healthcare data record storage system of claim 1 wherein the at least one active healthcare data record is purged from the active healthcare record database when the archived healthcare data record is stored in the archive healthcare record database.

4. The healthcare data record storage system of claim 2 wherein purging is based at least in part on the period of inactivity of the at least one active healthcare data record.

5. The healthcare data record storage system of claim 1 further comprising means for archiving at least one active healthcare data record from the active healthcare record database to a first level archive healthcare record database as one of the first level archived healthcare data records, wherein the archiving is based at least in part on the period of inactivity of the at least one active healthcare data record.

6. The healthcare data record storage system of claim 5 further comprising means for archiving at least one active healthcare data record from the active healthcare record database to a second level archive healthcare record database as one of the second level archived healthcare data records, wherein the archiving is based at least in part on the period of inactivity of the at least one active healthcare data record.

7. The healthcare data record storage system of claim 6 wherein the first level archive healthcare record database is a subset of the second level archive healthcare record database.

8. The healthcare data record storage system of claim 6 wherein the first level archive healthcare data records are archived for a predetermined period of time prior to being removed from the first level archive healthcare record database.

9. The healthcare data record storage system of claim 6 wherein all of the first level archive healthcare data records are also archived in the second level archive healthcare record database.

10. The healthcare data record storage system of claim 6 wherein all of the active healthcare data records are also archived in the second level archive healthcare record database.

11. The healthcare data record storage system of claim 6 wherein all of the second level archived healthcare data records are not removed from the second level archived healthcare record database.

12. The healthcare data record storage system of claim 1 wherein the active healthcare record database further comprises a plurality of healthcare data record tables containing the active healthcare data records.

13. The healthcare data record storage system of claim 12 wherein each of the plurality of healthcare data record tables comprises a specific healthcare data record group.

14. The healthcare data record storage system of claim 13 wherein the specific healthcare data record group comprises one of audit, lot, narcotics, patient, non-patient messages, inventory, login failures, shifts, HL7 interface information, and activity logs.

15. The healthcare data record storage system of claim 13 wherein each healthcare data record group is assigned a specific priority level.

16. The healthcare data record storage system of claim 15 wherein a retention period of the healthcare data record group is determined by the priority level

17. The healthcare data record storage system of claim 15 wherein each healthcare data record group comprises a predetermined time for archiving healthcare data records stored in the respective healthcare data record tables.

18. The healthcare data record storage system of claim 15 wherein at least one healthcare data record in the healthcare data record table is archived when a predetermined size of the healthcare data record table has been reached.

19. The healthcare data record storage system of claim 15 wherein at least one healthcare data record in the healthcare data record table is archived when a predetermined size of the active healthcare record database has been reached.

20. The healthcare data record storage system of claim 1 wherein the active healthcare record database further comprises a plurality of healthcare data record tables containing the active healthcare data records wherein at least one healthcare data record is linked to more than one of the plurality of healthcare data record tables.

21. The healthcare data record storage system of claim 1 wherein the active healthcare record database further comprises a foreign key for identifying a location of a linked healthcare data record wherein archiving of the linked healthcare database record occurs proximate in time with the archiving of the healthcare data record.

22. The healthcare data record storage system of claim 21 wherein the active healthcare record database further comprises a plurality of healthcare data record tables containing the active healthcare data records, wherein the foreign key comprises at least one healthcare data record table location of where the linked healthcare data record is located.

23. The healthcare data record storage system of claim 22 wherein the healthcare data record is located in a healthcare data record table of a first healthcare data record group and the linked healthcare data record is located in healthcare data record table of a second healthcare data record group.

24. The healthcare data record storage system of claim 23 wherein the first healthcare data record group and second healthcare data record group each comprise one of audit, lot, narcotic, patient, non-patient message, inventory, login failure, shift, HL7 interface information, and activity log.

25. The healthcare data record storage system of claim 1 further comprising a database server for the active healthcare record database and another database server for the first level archive healthcare record database.

26. A healthcare data record storage system, comprising:
an active healthcare record database having a plurality of active healthcare data records stored therein, wherein each of the plurality of active healthcare data records has a healthcare data record group associated therewith;
means for associating the healthcare data record group with the active healthcare data records; and, means for purging at least one active healthcare data record from the active healthcare record database, wherein the purging is based at least in part on the period of inactivity of the at least one active healthcare data record.

27. The healthcare data record storage system of claim 26 wherein the purging is automatically performed according to a predetermined schedule.

28. The healthcare data record storage system of claim 26 further comprising:
an archive healthcare record database having a plurality of archive healthcare data records stored therein; and,
means for purging at least one archive healthcare data record from the archive healthcare record database, wherein the purging is based at least in part on the period of inactivity of the at least one archive healthcare data record.

29. The healthcare data record storage system of claim 28 further comprising means for purging at least one archive healthcare data record from a first level archive healthcare record database as, wherein the purging is based at least in part on the period of inactivity of the at least one archive healthcare data record.

30. The healthcare data record storage system of claim 28 further comprising means for purging at least one archive healthcare data record from a second level archive healthcare record database, wherein the purging is based at least in part on the period of inactivity of the at least one archive healthcare data record.

31. The healthcare data record storage system of claim 29 wherein the first level archive healthcare record database is a subset of a second level archive healthcare record database.

32. The healthcare data record storage system of claim 29 wherein the first level archive healthcare data record is purged from the first level archive healthcare record database after a predetermined period of time.

33. The healthcare data record storage system of claim 29 wherein all of the first level archive healthcare data records are purged from the active healthcare record database.

34. The healthcare data record storage system of claim 26 wherein the active healthcare record database further comprises a plurality of healthcare data record groups containing the active healthcare data record tables.

35. The healthcare data record storage system of claim 34 wherein each of the plurality of healthcare data record tables comprises a specific healthcare data record group.

36. The healthcare data record storage system of claim 35 wherein the specific healthcare data record group comprises one of audit, lot, narcotics, patient, non-patient messages, inventory, login failures, shifts, HL7 interface information, and activity logs.

37. The healthcare data record storage system of claim 34 wherein each healthcare data record group is assigned a specific priority level.

38. The healthcare data record storage system of claim 37 wherein a purging order of the healthcare data records is determined by the priority level assigned to each healthcare data record group.

39. The healthcare data record storage system of claim 37 wherein each priority level comprises a predetermined sequence for purging healthcare data records stored in the respective healthcare data record group having such priority level.

40. The healthcare data record storage system of claim 34 wherein at least one healthcare data record in the healthcare data record group is purged when a predetermined size of the healthcare data record group has been reached.

41. The healthcare data record storage system of claim 34 wherein at least one healthcare data record in the healthcare data record group is purged when a predetermined size of the active healthcare record database has been reached.

42. The healthcare data record storage system of claim 26 wherein the active healthcare record database further comprises a foreign key for identifying a location of a linked healthcare data record wherein purging of the linked healthcare database record occurs proximate in time with the purging of the healthcare data record.

43. The healthcare data record storage system of claim 42 wherein the active healthcare record database further comprises a plurality of healthcare data record tables containing the active healthcare data records, wherein the foreign key comprises at least one healthcare data record table location of where the linked healthcare data record is located.

44. The healthcare data record storage system of claim 43 wherein the healthcare data record is located in a healthcare data record table of a first healthcare data record group and the linked healthcare data record is located in healthcare data record table of a second healthcare data record group.

45. The healthcare data record storage system of claim 44 wherein the first healthcare data record group and second healthcare data record group each comprise one of audit, lot, narcotic, patient, non-patient message, inventory, login failure, shift, HL7 interface information, and activity log.

46. The healthcare data record storage system of claim 1 or 26 further comprising:
means for activating at least one archive healthcare data record from the archive healthcare record database to the active healthcare record database as one of the active healthcare data records, wherein activating is based at least in part on the healthcare data record group.

47. The healthcare data record storage system of claim 1 or 26 further comprising:
means for archiving at least one archive healthcare data record from a first level archive healthcare record database to a second level archive healthcare record database as one of the second level archived healthcare data records, wherein the archiving is based at least in part on the period of inactivity of the at least one first level archive healthcare data record.

48. The healthcare data record storage system of claim 1 or 26 further comprising:
means for activating at least one first level archive healthcare data record from a first level archive healthcare record database to the active healthcare record database as one of the active healthcare data records, wherein activating is based at least in part on the healthcare data record group.

49. The healthcare data record storage system of claim 1 or 26 further comprising:
means for activating at least one second level archive healthcare data record from a second level archive healthcare record database to the active healthcare record database as one of the active healthcare data records, wherein activating is based at least in part on the healthcare data record group.

50. The healthcare data record storage system of claim 1 or 26 further comprising:
means for activating at least one second level archive healthcare data record from the second level archive healthcare record database to the first level archive healthcare record database as one of the first level archive healthcare data records, wherein activating is based at least in part on the healthcare data record group.

51. The healthcare data record storage system of claim 1 wherein the active database is in an SQL server format.

52. A method of archiving records in a healthcare data record storage system, comprising the steps of:
storing a plurality of active healthcare data records in an active healthcare record database, wherein each of the plurality of active healthcare data records is assigned a healthcare data record group; and,
archiving at least one active healthcare data record from the active healthcare record database to an archive healthcare record database as an archive healthcare data record, wherein the archiving is based at least in part on the period of inactivity of the at least one active healthcare data record.

53. The method of archiving records in a healthcare data record storage system of claim 52 further comprising the step of:
purging the at least one active healthcare data record of the active healthcare record database.

54. The method of archiving records in a healthcare data record storage system of claim 52 further comprising the step of:
purging the at least one active healthcare data record from the active healthcare record database after the active healthcare data record is stored in the archive healthcare record database.

55. The method of archiving records in a healthcare data record storage system of claim 52 further comprising the step of:
purging the at least one active healthcare data record based at least in part on the period of inactivity of the at least one active healthcare data record.

56. The method of archiving records in a healthcare data record storage system of claim 52 further comprising the step of:
archiving at least one active healthcare data record from the active healthcare record database to a first level archive healthcare record database as one of a first level archived healthcare data record, wherein the archiving is based at least in part on the period of inactivity of the at least one active healthcare data record.

57. The method of archiving records in a healthcare data record storage system of claim 52 further comprising the step of:
archiving at least one active healthcare data record from the active healthcare record database to a second level archive healthcare record database as one of a second level archived healthcare data record, wherein the archiving is based at least in part on the period of inactivity of the at least one active healthcare data record.

58. The method of archiving records in a healthcare data record storage system of claim 52 wherein the first level archive healthcare record database is a subset of the second level archive healthcare record database.

59. The method of archiving records in a healthcare data record storage system of claim 52 further comprising the step of:
archiving the first level archive healthcare data record for a predetermined period of time prior to being removed from the first level archive healthcare record database.

60. The method of archiving records in a healthcare data record storage system of claim 52 further comprising the step of:
archiving all of the first level archive healthcare data records in the second level archive healthcare record database.

61. The method of archiving records in a healthcare data record storage system of claim 52 further comprising the step of:
archiving all of the active healthcare data records in the second level archive healthcare record database.

62. The method of archiving records in a healthcare data record storage system of claim 52 further comprising the step of:
maintaining all of the second level archived healthcare data records in the second level archived healthcare record database without purging.

63. The method of archiving records in a healthcare data record storage system of claim 52 wherein the active healthcare record database further comprises a plurality of healthcare data record tables containing the active healthcare data records.

64. The method of archiving records in a healthcare data record storage system of claim 63 wherein each of the plurality of healthcare data record tables comprises a specific healthcare data record group.

65. The method of archiving records in a healthcare data record storage system of claim 52 wherein the specific healthcare data record group comprises one of audit, lot, narcotic, patient, non-patient message, inventory, login failure, shift, HL7 interface information, and activity log.

66. The method of archiving records in a healthcare data record storage system of claim 63 further comprising the step of:
assigning each healthcare data record group a specific priority level.

67. The method of archiving records in a healthcare data record storage system of claim 66 further comprising the step of:
determining a retention period of the healthcare data record group by the priority level.

68. The method of archiving records in a healthcare data record storage system of claim 66 further comprising the step of:
archiving data records stored in the respective healthcare data record group and having a priority level, for a predetermined time, the predetermined time determined by such priority level.

69. The method of archiving records in a healthcare data record storage system of claim 63 further comprising the step of:
archiving at least one healthcare data record in the healthcare data record group when a predetermined size of the healthcare data record group has been reached.

70. The method of archiving records in a healthcare data record storage system of claim 63 further comprising the step of:
archiving at least one healthcare data record in the healthcare data record group when a predetermined size of the active healthcare record database has been reached.

71. The method of archiving records in a healthcare data record storage system of claim 63 wherein the active healthcare record database further comprises the step of:
storing at least one active healthcare data record in a plurality of healthcare data record tables.

72. The method of archiving records in a healthcare data record storage system of claim 52 further comprises the step of:
identifying a location of a linked healthcare data record from the active healthcare record database with a foreign key wherein archiving of the linked healthcare database record occurs proximate in time with the archiving of the healthcare data record.

73. The method of archiving records in a healthcare data record storage system of claim 72 wherein the active healthcare record database further comprises a plurality of healthcare data record tables containing the active healthcare data records, wherein the foreign key comprises at least one healthcare data record table location of where the linked healthcare data record is located.

74. The method of archiving records in a healthcare data record storage system of claim 63 further comprises the steps of:
storing the healthcare data record in a healthcare data record table of a first healthcare data record group; and,
linking a healthcare data record in healthcare data record table of a second healthcare data record group.

75. The method of archiving records in a healthcare data record storage system of claim 52 wherein the first healthcare data record group and second healthcare data record group each comprise one of audit, lot, narcotic, patient, non-patient message, inventory, login failure, shift, HL7 interface information, and activity log.

76. The method of archiving records in a healthcare data record storage system of claim 56 further comprising the step of:
using a database server for the active healthcare record database and another database server for the first level archive healthcare record database.

77. A method of archiving records in a healthcare data record storage system comprising:
storing a plurality of active healthcare data records in an active healthcare record database, wherein each of the plurality of active healthcare data records has a healthcare data record group; and,
purging at least one active healthcare data record from the active healthcare record database, wherein the purging is based at least in part on the period of inactivity of the at least one active healthcare data record.

78. The method of archiving records in a healthcare data record storage system of claim 77 wherein purging is performed automatically, according to a predetermined schedule.

79. The method of archiving records in a healthcare data record storage system of claim 77 further comprising the step of::
purging at least one archive healthcare data record from an archive healthcare record database having a plurality of archive healthcare data records stored therein, wherein the purging is based at least in part on the period of inactivity of the at least one archive healthcare data record.

80. The method of archiving records in a healthcare data record storage system of claim 79 further comprising the step of:
purging at least one archive healthcare data record from a first level archive healthcare record database as, wherein the purging is based at least in part on the period of inactivity of the at least one archive healthcare data record.

81. The method of archiving records in a healthcare data record storage system of claim 79 further comprising the step of:
purging at least one archive healthcare data record from the second level archive healthcare record database, wherein the purging is based at least in part on the period of inactivity of the at least one archive healthcare data record.

82. The method of archiving records in a healthcare data record storage system of claim 81 wherein the first level archive healthcare record database is a subset of a second level archive healthcare record database.

83. The method of archiving records in a healthcare data record storage system of claim 80 further comprising the step of:
purging the first level archive healthcare data record from the first level archive healthcare record database at a predetermined period of time.

84. The method of archiving records in a healthcare data record storage system of claim 80 further comprising the step of:
purging all of the first level archive healthcare data records from the active healthcare record database.

85. The method of archiving records in a healthcare data record storage system of claim 77 wherein the active healthcare record database further comprises a plurality of healthcare data record tables containing the active healthcare data records.

86. The method of archiving records in a healthcare data record storage system of claim 85 wherein each of the plurality of healthcare data record tables comprises a specific healthcare data record group.

87. The method of archiving records in a healthcare data record storage system of claim 77 wherein the specific healthcare data record group comprises one of audit, lot, narcotics, patient, non-patient messages, inventory, login failures, shifts, HL7 interface information, and activity logs.

88. The method of archiving records in a healthcare data record storage system of claim 85 further comprising the step of:
assigning each healthcare data record group a specific priority level.

89. The method of archiving records in a healthcare data record storage system of claim 88 further comprising the step of:
determining a purging order of the healthcare data records by the priority level assigned to each healthcare data record group.

90. The method of archiving records in a healthcare data record storage system of claim 88 further comprising the step of:
purging healthcare data records having a priority level and stored in the healthcare data record group wherein the priority level comprises a predetermined time for purging.

91. The method of archiving records in a healthcare data record storage system of claim 85 further comprising the step of:
purging at least one healthcare data record in the healthcare data record group when a predetermined size of the healthcare data record group has been reached.

92. The method of archiving records in a healthcare data record storage system of claim 85 further comprising the step of:
purging at least one healthcare data record in the healthcare data record group when a predetermined size of the active healthcare record database has been reached.

93. The method of archiving records in a healthcare data record storage system of claim 77 further comprising the step of:
identifying a location of a linked healthcare data record of the active healthcare record database with a foreign key wherein purging of the linked healthcare database record occurs proximate in time with the purging of the healthcare data record.

94. The method of archiving records in a healthcare data record storage system of claim 93 wherein the active healthcare record database further comprises a plurality of healthcare data record tables containing the active healthcare data records, wherein the foreign key comprises at least one healthcare data record table location of where the linked healthcare data record is located.

95. The method of archiving records in a healthcare data record storage system of claim 94 wherein the healthcare data record is located in a healthcare data record table of a first healthcare data record group and the linked healthcare data record is located in healthcare data record table of a second healthcare data record group.

96. The method of archiving records in a healthcare data record storage system of claim 95 wherein the first healthcare data record group and second healthcare data record group each comprise one of audit, lot, narcotic, patient, non-patient message, inventory, login failure, shift, HL7 interface information, and activity log.

97. The method of archiving records in a healthcare data record storage system of claim 77 further comprising the step of:
activating at least one archive healthcare data record from the archive healthcare record database to the active healthcare record database as one of the active healthcare data records, wherein activating is based at least in part on the healthcare data record group.

98. The method of archiving records in a healthcare data record storage system of claim 52 or 77 further comprising the step of:
archiving at least one archive healthcare data record from a first level archive healthcare record database to a second level archive healthcare record database as one of the second level archived healthcare data records, wherein the archiving is based at least in part on the period of inactivity of the at least one first level archive healthcare data record.

99. The method of archiving records in a healthcare data record storage system of claim 52 or 77 further comprising the step of:
activating at least one first level archive healthcare data record from a first level archive healthcare record database to the active healthcare record database as one of the active healthcare data records, wherein activating is based at least in part on the healthcare data record group.

100. The method of archiving records in a healthcare data record storage system of claim 52 or 77 further comprising the step of:
activating at least one second level archive healthcare data record from a second level archive healthcare record database to the active healthcare record database as one of the active healthcare data records, wherein activating is based at least in part on the healthcare data record group.

101. The method of archiving records in a healthcare data record storage system of claim 52 or 77 further comprising the step of:
activating at least one second level archive healthcare data record from a second level archive healthcare record database to a first level archive healthcare record database as one of the first level archive healthcare data records, wherein activating is based at least in part on the healthcare data record group.

102. A method of archiving records in a healthcare data record storage system, comprising the steps of:
storing a plurality of active healthcare data records in an active healthcare record database, wherein each of the plurality of active healthcare data records is assigned a healthcare data record group; and,
archiving at least one active healthcare data record from the active healthcare record database to the archive healthcare record database as archive healthcare data records, wherein the archiving is based at least in part on the period of inactivity of the at least one active healthcare data record.

103. A computer readable medium having a computer program thereon for storing healthcare data records, the medium comprising:
a first code segment for storing a plurality of active healthcare data records in an active healthcare record database, wherein each of the plurality of active healthcare data records is assigned a healthcare data record group; and,
a second code segment for archiving at least one active healthcare data record from the active healthcare record database to an archive healthcare record database as an archive healthcare data record, wherein the archiving is based at least in part on the period of inactivity of the at least one active healthcare data record.

104. The computer readable medium of claim 103, further comprising:
a third code segment for purging the at least one active healthcare data record of the active healthcare record database.

105. The computer readable medium of claim 103, further comprising:
a third code segment for purging the at least one active healthcare data record from the active healthcare record database after the archived healthcare data record is stored in the archive healthcare record database.

106. The computer readable medium of claim 103, further comprising:
a third code segment for purging the at least one active healthcare data record based at least in part on the period of inactivity of the at least one active healthcare data record.

107. The computer readable medium of claim 103, further comprising:
a third code segment for archiving at least one active healthcare data record from the active healthcare record database to a first level archive healthcare record database as one of a first level archived healthcare data record, wherein the archiving is based at least in part on the period of inactivity of the at least one active healthcare data record.

108. The computer readable medium of claim 103, further comprising:
a third code segment for archiving at least one active healthcare data record from the active healthcare record database to a second level archive healthcare record database as one of a second level archived healthcare data record, wherein the archiving is based at least in part on the period of inactivity of the at least one active healthcare data record.

109. The computer readable medium of claim 103 wherein the first level archive healthcare record database is a subset of the second level archive healthcare record database.

110. The computer readable medium of claim 103, further comprising:
a third code segment for archiving the first level archive healthcare data records for a predetermined period of time prior to being removed from the first level archive healthcare record database.

111. The computer readable medium of claim 103, further comprising:
a third code segment for archiving all of the first level archive healthcare data records in the second level archive healthcare record database.

112. The computer readable medium of claim 103, further comprising:
a third code segment for archiving all of the active healthcare data records in the second level archive healthcare record database.

113. The computer readable medium of claim 103, further comprising:
a third code segment for maintaining all of the second level archived healthcare data records in the second level archived healthcare record database without purging.

114. The computer readable medium of claim 103 wherein the active healthcare record database further comprises a plurality of healthcare data record tables containing the active healthcare data records.

115. The computer readable medium of claim 103 wherein each of the plurality of healthcare data record tables comprises a specific healthcare data record group.

116. The computer readable medium of claim 103 wherein the specific healthcare data record group comprises one of audit, lot, narcotic, patient, non-patient message, inventory, login failure, shift, HL7 interface information, and activity log.

117. The computer readable medium of claim 103, further comprising:
a third code segment for assigning each healthcare data record group a specific priority level.

118. The computer readable medium of claim 103, further comprising:
a third code segment for determining a retention period of the healthcare data record group by the priority level.

119. The computer readable medium of claim 103, further comprising:
a third code segment for archiving healthcare data records stored in the respective healthcare data record group and having a priority level, for a predetermined time, the predetermined time determined by such priority level.

120. The computer readable medium of claim 103, further comprising:
a third code segment for archiving at least one healthcare data record in the healthcare data record group when a predetermined size of the healthcare data record group has been reached.

121. The computer readable medium of claim 103, further comprising:
a third code segment for archiving at least one healthcare data record in the healthcare data record group when a predetermined size of the active healthcare record database has been reached.

122. The computer readable medium of claim 103, further comprising:
a third code segment for storing at least one active healthcare data record in a plurality of healthcare data record tables.

123. The computer readable medium of claim 103, further comprising:
a third code segment for identifying a location of a linked healthcare data record from the active healthcare record database with a foreign key wherein archiving of the linked healthcare database record occurs proximate in time with the archiving of the healthcare data record.

124. The computer readable medium of claim 103 wherein the active healthcare record database further comprises a plurality of healthcare data record tables containing the active healthcare data records, wherein the foreign key comprises at least one healthcare data record table location of where the linked healthcare data record is located.

125. The computer readable medium of claim 103, further comprising:
a third code segment for storing the healthcare data record in a healthcare data record table of a first healthcare data record group; and,
a fourth code segment for linking a healthcare data record in healthcare data record table of a second healthcare data record group.

126. The computer readable medium of claim 103 wherein the first healthcare data record group and second healthcare data record group each comprise one of audit, lot, narcotic, patient, non-patient message, inventory, login failure, shift, HL7 interface information, and activity log.

127. The computer readable medium of claim 103, further comprising:
a third code segment for using a database server for the active healthcare record database and another database server for the first level archive healthcare record database.

128. A computer readable medium having a computer program thereon for storing healthcare data records, comprising:
a first code segment for storing a plurality of active healthcare data records in an active healthcare record database, wherein each of the plurality of active healthcare data records is assigned a healthcare data record group; and,
a second code segment for purging at least one active healthcare data record from the active healthcare record database, wherein the purging is based at least in part on the period of inactivity of the at least one active healthcare data record.

129. The computer readable medium of claim 128, further comprising:
a third code segment for purging automatically according to a predetermined schedule.

130. The computer readable medium of claim 128, further comprising:
a third code segment for purging at least one archive healthcare data record from an archive healthcare record database having a plurality of archive healthcare data records stored therein, wherein the purging is based at least in part on the period of inactivity of the at least one archive healthcare data record.

131. The computer readable medium of claim 130, further comprising:
a third code segment for purging at least one archive healthcare data record from a first level archive healthcare record database as, wherein the purging is based at least in part on the period of inactivity of the at least one archive healthcare data record.

132. The computer readable medium of claim 130, further comprising:
a third code segment for purging at least one archive healthcare data record from a second level archive healthcare record database, wherein the purging is based at least in part on the period of inactivity of the at least one archive healthcare data record.

133. The computer readable medium of claim 132 wherein the first level archive healthcare record database is a subset of the second level archive healthcare record database.

134. The computer readable medium of claim 131, further comprising:
a third code segment for purging the first level archive healthcare data record from the first level archive healthcare record database at a predetermined period of time.

135. The computer readable medium of claim 131, further comprising:
a third code segment for purging all of the first level archive healthcare data records from the active healthcare record database.

136. The computer readable medium of claim 128 wherein the active healthcare record database further comprises a plurality of healthcare data record tables containing the active healthcare data records.

137. The computer readable medium of claim 136 wherein each of the plurality of healthcare data record tables comprises a specific healthcare data record group.

138. The computer readable medium of claim 137 wherein the specific healthcare data record group comprises one of audit, lot, narcotics, patient, non-patient messages, inventory, login failures, shifts, HL7 interface information, and activity logs.

139. The computer readable medium of claim 136, further comprising:
a third code segment for assigning each healthcare data record group a specific priority level.

140. The computer readable medium of claim 139, further comprising: a third code segment for determining a purging order of the healthcare data records by the priority level assigned to each healthcare data record group.

141. The computer readable medium of claim 139, further comprising:
a third code segment for purging healthcare data records having a priority level and stored in the healthcare data record group wherein the priority level comprises a predetermined time for purging.

142. The computer readable medium of claim 136, further comprising:
a third code segment for purging at least one healthcare data record in the healthcare data record group when a predetermined size of the healthcare data record group has been reached.

143. The computer readable medium of claim 136, further comprising:
a third code segment for purging at least one healthcare data record in the healthcare data record group when a predetermined size of the active healthcare record database has been reached.

144. The computer readable medium of claim 128, further comprising:
a third code segment for identifying a location of a linked healthcare data record of the active healthcare record database with a foreign key wherein purging of the linked healthcare database record occurs proximate in time with the purging of the healthcare data record.

145. The computer readable medium of claim 144 wherein the active healthcare record database further comprises a plurality of healthcare data record tables containing the active healthcare data records, wherein the foreign key comprises at least one healthcare data record table location of where the linked healthcare data record is located.

146. The computer readable medium of claim 145 wherein the healthcare data record is located in a healthcare data record table of a first healthcare data record group and the linked healthcare data record is located in healthcare data record table of a second healthcare data record group.

147. The computer readable medium of claim 146 wherein the first healthcare data record group and second healthcare data record group each comprise one of audit, lot, narcotic, patient, non-patient message, inventory, login failure, shift, HL7 interface information, and activity log.

148. The computer readable medium of claim 128, further comprising:
a third code segment for activating at least one archive healthcare data record from the archive healthcare record database to the active healthcare record database as one of the active healthcare data records, wherein activating is based at least in part on the healthcare data record group.

149. The computer readable medium of claim 128, further comprising:
a third code segment for archiving at least one archive healthcare data record from a first level archive healthcare record database to a second level archive healthcare record database as one of the second level archived healthcare data records, wherein the archiving is based at least in part on the period of inactivity of the at least one first level archive healthcare data record.

150. The computer readable medium of claim 128 further comprising:
a third code segment for activating at least one first level archive healthcare data record from a first level archive healthcare record database to the active healthcare record database as one of the active healthcare data records, wherein activating is based at least in part on the healthcare data record group.

151. The computer readable medium of claim 128 further comprising:
a third code segment for activating at least one second level archive healthcare data record from a second level archive healthcare record database to the active healthcare record database as one of the active healthcare data records, wherein activating is based at least in part on the healthcare data record group.

152. The computer readable medium of claim 128 further comprising:
a third code segment for activating at least one second level archive healthcare data record from the second level archive healthcare record database to the first level archive healthcare record database as one of the first level archive healthcare data records, wherein activating is based at least in part on the healthcare data record group.

153. The computer readable medium of claim 128 further comprising:
a third code segment for storing a plurality of active healthcare data records in an active healthcare record database, wherein each of the plurality of active healthcare data records is assigned a healthcare data record group; and,
a fourth code segment for archiving at least one active healthcare data record from the active healthcare record database to the archive healthcare record database as archive healthcare data records, wherein the archiving is based at least in part on the period of inactivity of the at least one active healthcare data record.

154. A method of accessing healthcare data in a healthcare facility having a communication network, a medical storage depot, and a central memory communicating with the medical storage depot, the medical storage depot having a depot memory, the method comprising the steps of:
storing healthcare data relating to the medical storage depot in the central memory and the depot memory;
determining whether the central memory is communicating with the medical storage depot; and,
using the healthcare data relating to the medical storage depot in the depot memory when it is determined that the central memory is not communicating with the depot memory.

155. The method of claim 154, further comprising the step of:
tracking at least a portion of the central memory relating to healthcare transactions in the depot memory.

156. The method of claim 154, further comprising the step of:
tracking at least a portion of the depot memory relating to healthcare transactions in the central memory.

157. The method of claim 154 wherein storing healthcare data relating to the medical storage depot includes selecting the healthcare data in the central memory.

158. The method of claim 154 wherein storing healthcare data relating to the medical storage depot includes selecting the healthcare data in the depot memory.

159. The method of claim 154 wherein storing healthcare data relating to the medical storage depot includes deleting the healthcare data in the central memory.

160. The method of claim 154 wherein storing healthcare data relating to the medical storage depot includes deleting the healthcare data in the depot memory.

161. The method of claim 154 wherein storing healthcare data relating to the medical storage depot includes inserting the healthcare data in the central memory.

162. The method of claim 154 wherein storing healthcare data relating to the medical storage depot includes inserting the healthcare data in the depot memory.

163. The method of claim 154 wherein storing healthcare data relating to the medical storage depot includes updating the healthcare data in the central memory.

164. The method of claim 154 wherein storing healthcare data relating to the medical storage depot includes updating the healthcare data in the depot memory.

165. The method of claim 154 wherein storing healthcare data relating to the medical storage depot includes purging the healthcare data in the central memory.

166. The method of claim 154 wherein storing healthcare data relating to the medical storage depot includes purging the healthcare data in the depot memory.

167. The method of claim 154 wherein storing healthcare data relating to the medical storage depot includes archiving the healthcare data in the central memory.

168. The method of claim 154 wherein storing healthcare data relating to the medical storage depot includes archiving the healthcare data in the depot memory.

169. The method of claim 154 wherein healthcare data relating to the medical storage depot includes activity logs.

170. The method of claim 154 wherein healthcare data relating to the medical storage depot includes error logs.

171. The method of claim 154 wherein healthcare data relating to the medical storage depot includes medical storage depot access data.

172. The method of claim 154 wherein healthcare data relating to the medical storage depot includes inventory audit data.

173. The method of claim 154 wherein healthcare data relating to the medical storage depot includes medication fill orders.

174. The method of claim 154 wherein healthcare data relating to the medical storage depot includes medical storage depot configuration parameters.

175. The method of claim 154 wherein healthcare data relating to the medical storage depot includes patient medical history.

175. The method of claim 154 wherein healthcare data relating to the medical storage depot includes medical item information.

176. The method of claim 154 wherein healthcare data relating to the medical storage depot includes healthcare personnel data.

177. The method of claim 154 wherein healthcare data relating to the medical storage depot includes cart fill item history.

178. The method of claim 154 wherein healthcare data relating to the medical storage depot includes medical item history.

179. The method of claim 154 wherein healthcare data relating to the medical storage depot includes medical item delivery information.

180. The method of claim 154, further comprising the steps of:
comparing a first copy of a first electronic biometric identification and a second electronic biometric identification at the medical storage depot; and,
generating a medical storage depot access signal from the medical storage depot when communication between the medical storage depot and the central memory is lost.

181. The method of claim 154, further comprising the steps of:
comparing a first copy of a first electronic biometric identification and a second electronic biometric identification at the medical storage depot; and,
generating a medical storage depot access signal from the central memory when communication between the medical storage depot and the central memory exists.

182. A computer readable medium having a computer program thereon for accessing healthcare data in a healthcare facility having a communication network, a medical storage depot, and a central memory communicating with the medical storage depot, the medical storage depot having a depot memory, the medium comprising:
a first code segment for storing healthcare data relating to the medical storage depot in the central memory and the depot memory;
a second code segment for determining whether the central memory is communicating with the medical storage depot; and,
a third code segment for using the healthcare data relating to the medical storage depot in the depot memory when it is determined that the central memory is not communicating with the depot memory.

183. The computer readable medium of claim 182, further comprising:
a fourth code segment for tracking at least a portion of the central memory relating to healthcare transactions in the depot memory.

184. The computer readable medium of claim 182, further comprising:
a fourth code segment for tracking at least a portion of the depot memory relating to healthcare transactions in the central memory.

185. The computer readable medium of claim 182 wherein storing healthcare data relating to the medical storage depot includes selecting the healthcare data in the central memory.

186. The computer readable medium of claim 182 wherein storing healthcare data relating to the medical storage depot includes selecting the healthcare data in the depot memory.

187. The computer readable medium of claim 182 wherein storing healthcare data relating to the medical storage depot includes deleting the healthcare data in the central memory.

188. The computer readable medium of claim 182 wherein storing healthcare data relating to the medical storage depot includes deleting the healthcare data in the depot memory.

189. The computer readable medium of claim 182 wherein storing healthcare data relating to the medical storage depot includes inserting the healthcare data in the central memory.

190. The computer readable medium of claim 182 wherein storing healthcare data relating to the medical storage depot includes inserting the healthcare data in the depot memory.

191. The computer readable medium of claim 182 wherein storing healthcare data relating to the medical storage depot includes updating the healthcare data in the central memory.

192. The computer readable medium of claim 182 wherein storing healthcare data relating to the medical storage depot includes updating the healthcare data in the depot memory.

193. The computer readable medium of claim 182 wherein storing healthcare data relating to the medical storage depot includes purging the healthcare data in the central memory.

194. The computer readable medium of claim 182 wherein storing healthcare data relating to the medical storage depot includes purging the healthcare data in the depot memory.

195. The computer readable medium of claim 182 wherein storing healthcare data relating to the medical storage depot includes archiving the healthcare data in the central memory.

196. The computer readable medium of claim 182 wherein storing healthcare data relating to the medical storage depot includes archiving the healthcare data in the depot memory.

197. The computer readable medium of claim 182 wherein healthcare data relating to the medical storage depot includes activity logs.

198. The computer readable medium of claim 182 wherein healthcare data relating to the medical storage depot includes error logs.

199. The computer readable medium of claim 182 wherein healthcare data relating to the medical storage depot includes medical storage depot access data.

200. The computer readable medium of claim 182 wherein healthcare data relating to the medical storage depot includes inventory audit data.

201. The computer readable medium of claim 182 wherein healthcare data relating to the medical storage depot includes medication fill orders.

202. The computer readable medium of claim 182 wherein healthcare data relating to the medical storage depot includes medical storage depot configuration parameters.

203. The computer readable medium of claim 182 wherein healthcare data relating to the medical storage depot includes patient medical history.

204. The computer readable medium of claim 182 wherein healthcare data relating to the medical storage depot includes medical item information.

205. The computer readable medium of claim 182 wherein healthcare data relating to the medical storage depot includes healthcare personnel data.

206. The computer readable medium of claim 182 wherein healthcare data relating to the medical storage depot includes cart fill item history.

207. The computer readable medium of claim 182 wherein healthcare data relating to the medical storage depot includes medical item history.

208. The computer readable medium of claim 182 wherein healthcare data relating to the medical storage depot includes medical item delivery information.

209. The computer readable medium of claim 182, further comprising:
a fourth code segment for comparing a first copy of a first electronic biometric identification and a second electronic biometric identification at the medical storage depot; and,
a fifth code segment for generating a medical storage depot access signal from the medical storage depot when communication between the medical storage depot and the central memory is lost.

210. The computer readable medium of claim 182, further comprising:
a fourth code segment for comparing a first copy of a first electronic biometric identification and a second electronic biometric identification at the medical storage depot; and,
a fifth code segment for generating a medical storage depot access signal from the central memory when communication between the medical storage depot and the central memory exists.

211. A system for accessing healthcare data in a healthcare facility, comprising:
a central memory having a central database;
a depot memory having a depot database; and,
a network communicatively connecting the depot and central memories, wherein database modifications are sent from the central memory to the depot memory.

212. The system for accessing healthcare data in the healthcare facility of claim 211 wherein database modifications are sent from the central memory to the depot memory.

213. The system for accessing healthcare data in the healthcare facility of claim 211, further comprising:
a download signal containing depot database modifications.

214. The system for accessing healthcare data in the healthcare facility of claim 211, further comprising:
an upload signal containing central database modifications.

215. The system for accessing healthcare data in the healthcare facility of claim 211, further comprising:
a database synchronization module that sends upload and download signals through the network at predetermined intervals while the depot memory and central memory are communicatively connected.

216. The system for accessing healthcare data in the healthcare facility of claim 211, further comprising:
a database synchronization module that sends upload and download signals through the network at predetermined intervals when communication between the depot memory and central memory is reestablished after a network disconnection.

217. The system for accessing healthcare data in the healthcare facility of claim 211, further comprising:
a database refresh module that updates the depot database when a modification signal is received.

218. The system for accessing healthcare data in the healthcare facility of claim 211, further comprising:
a database refresh module that updates the central database when a modification signal is received.

219. A system for accessing healthcare data in the healthcare facility, comprising:
a medical storage depot having a depot processor and a depot memory, wherein the depot memory comprises healthcare data and a communication module;
a communication network; and,
a central processor having a central memory and being capable of communicating with the depot processor and depot memory over the communication network.

220. The system for accessing healthcare data in the healthcare facility of claim 219 wherein the central memory is capable of tracking healthcare data relating to healthcare transactions in the depot memory.

221. The system for accessing healthcare data in the healthcare facility of claim 219 wherein the depot memory is capable of tracking healthcare data relating to healthcare transactions in the central memory.

222. The system for accessing healthcare data in the healthcare facility of claim 219 wherein the medical storage depot is lockable.

223. The system for accessing healthcare data in the healthcare facility of claim 219 wherein the healthcare data in the central memory can be selected.

224. The system for accessing healthcare data in the healthcare facility of claim 219 wherein the healthcare data in the depot memory can be selected.

225. The system for accessing healthcare data in the healthcare facility of claim 219 wherein the healthcare data in the central memory can be deleted.

226. The system for accessing healthcare data in the healthcare facility of claim 219 wherein the healthcare data in the depot memory can be deleted.

227. The system for accessing healthcare data in the healthcare facility of claim 219 wherein the healthcare data in the central memory can be inserted.

228. The system for accessing healthcare data in the healthcare facility of claim 219 wherein the healthcare data in the depot memory can be inserted.

229. The system for accessing healthcare data in the healthcare facility of claim 219 wherein the healthcare data in the central memory can be updated.

230. The system for accessing healthcare data in the healthcare facility of claim 219 wherein the healthcare data in the depot memory can be updated.

231. The system for accessing healthcare data in the healthcare facility of claim 219 wherein the healthcare data in the central memory can be purged.

232. The system for accessing healthcare data in the healthcare facility of claim 219 wherein the healthcare data in the depot memory can be purged.

233. The system for accessing healthcare data in the healthcare facility of claim 219 wherein the healthcare data in the central memory can be archived.

234. The system for accessing healthcare data in the healthcare facility of claim 219 wherein the healthcare data in the depot memory can be archived.

235. The system for accessing healthcare data in the healthcare facility of claim 219 wherein healthcare data includes activity logs.

236. The system for accessing healthcare data in the healthcare facility of claim 219 wherein healthcare data includes error logs.

237. The system for accessing healthcare data in the healthcare facility of claim 219 wherein healthcare data includes medical storage depot access data.

238. The system for accessing healthcare data in the healthcare facility of claim 219 wherein healthcare data includes inventory audit data.

239. The system for accessing healthcare data in the healthcare facility of claim 219 wherein healthcare data relating to the medical storage depot includes medication fill orders.

240. The system for accessing healthcare data in the healthcare facility of claim 219 wherein healthcare data includes medical storage depot configuration parameters.

241. The system for accessing healthcare data in the healthcare facility of claim 219 wherein healthcare data includes patient medical history.

242. The system for accessing healthcare data in the healthcare facility of claim 219 wherein healthcare data includes medical item information.

243. The system for accessing healthcare data in the healthcare facility of claim 219 wherein healthcare data includes healthcare personnel data.

244. The system for accessing healthcare data in the healthcare facility of claim 219 wherein healthcare data includes cart fill item history.

245. The system for accessing healthcare data in the healthcare facility of claim 219 wherein healthcare data includes medical item history.

246. The system for accessing healthcare data in the healthcare facility of claim 219 wherein healthcare data relating to the medical storage depot includes medical item delivery information.

247. The system for accessing healthcare data in the healthcare facility of claim 219, further comprising:
a first copy of a first electronic biometric identification and a second electronic biometric identification at the medical storage depot; and,
a medical storage depot access signal sent from the medical storage depot when communication between the medical storage depot and the central memory is lost.

248. The system for accessing healthcare data in the healthcare facility of claim 219, further comprising:
a first copy of a first electronic biometric identification and a second electronic biometric identification at the medical storage depot; and,
a medical storage depot access signal from the central memory when communication between the medical storage depot and the central memory exists.

249. The system for accessing healthcare data in the healthcare facility of claim 219 wherein the depot memory comprises at least one SQL server database.

250. The system for accessing healthcare data in the healthcare facility of claim 219 wherein the central memory comprises at least one SQL server database.
